(19) United States
(12) Patent Application Publication
(10) Pub. No.: US 2002/0007546 A1
(43) Pub. Date: Jan. 24, 2002

(54) Advanced alloy fiber and process of making

(75) Inventors: Nathaniel R. Quick, Lake Mary, FL (US); Alexander Sobolevsky, Deland, FL (US); Dean A. Roberts, Deland, FL (US)

Correspondence Address: Robert F. Frijouf, Frijouf, Rust & Pyle, P.A., 201 East Davis Boulevard, Tampa, FL, 33606, US

(73) Assignee: USF Filtration & Separations Group, Inc, Timonium, MD (US)

(21) Appl. No.: 09/745,770

(22) Filed: Dec. 22, 2000

Related U.S. Application Data
(60) Provisional application No. 60/172,030, filed on Dec. 23, 1999.

(51) Int. Cl. B23P 17/00

(52) U.S. Cl. 29/419.1

(57) ABSTRACT

A process is disclosed for making fine metallic alloy fibers from a metallic alloy wire having plural alloy components and encompassed by a cladding material. Preferably, the cladding material is tightened about the metallic alloy wire in the presence of an inert atmosphere. The cladding is drawn for reducing the outer diameter thereof to provide a drawn cladding encompassing a fine metallic alloy fiber. The cladding material is removed for providing the fine metallic alloy fiber. A portion of the cladding material diffuses into the fine metallic alloy fiber. The cladding material may be selected for providing a fine metallic alloy fiber formed from a new alloy material and/or providing a fine metallic alloy fiber having surface properties in accordance with the properties of the selected cladding material.

### BACKGROUND OF THE INVENTION

1. Field of the Invention

This invention relates to metallic alloys, and more particularly to an improved process for producing metallic alloys in the forms of a metallic alloy fiber. This invention relates further to the production of a fine metallic alloy fiber formed from a new alloy and/or a fine metallic alloy fiber having different surface properties.

2. Background of the Invention

Metallic alloys have been utilized in many applications of use over pure metals due to the many desirable qualities of metallic alloys. Many metallic alloys exhibit the desirable qualities of a higher melting point, a greater hardness, and a greater chemical stability relative to pure metals. Typically, metallic alloys are high strength materials. Many metallic alloys have a high tolerance for corrosion resistance making metallic alloys desirable for use in hostile environments and the like. In addition, metallic alloys typically have high melting points making the metallic alloys desirable for high temperature applications. Unfortunately, some corrosion resistant and heat resistant metallic alloys exhibit low ductility and low-temperature brittleness.

Metallic alloys are metallic solid solutions formed from two or more dissimilar metals. The two or more dissimilar metals are heated to diffuse or melted together to convert the dissimilar metals into the solid solution. The metallic alloys are typically formed by powder metallurgy methods or by melt processing of stoichiometric single crystals.

Metallic alloys may be formed by mixing two or more dissimilar powdered metals. The mixed powders are heated to diffuse or melt together dissimilar metals to convert the dissimilar metals into the metallic alloy. After the conversion into the metallic alloy, the low ductility and low-temperature brittleness of the metallic alloy makes the metallic alloy difficult to deform, mold or machine.

In many cases, the dissimilar powdered metals are formed into a general shape of the desired item prior to converting the dissimilar powdered metals into the metallic alloy. This formation of the dissimilar powdered metals into the general shape of the desired item, overcomes the difficulty in deforming, molding or machining after conversion into the metal alloy.

In addition to the powder metallurgy methods set forth above, metallic alloys may be formed by the melt processing of stoichiometric single crystals. Unfortunately, neither of these methods is suitable for the formation of alloy wire. The low ductility and low-temperature brittleness of these metallic alloys made the production of metallic alloy wire a perplexing task. Furthermore, the low ductility and low-temperature brittleness of metallic alloy wire made the subsequent processing such as a successive wire drawing process of a metallic alloy wire a futile endeavor. Although small wires can be formed with metallic alloys, fine alloy fibers have heretofore not been formed due to the difficulty of drawing alloy wires into alloy fibers in a successive wire drawing process.

Many in the prior art have attempted to form very small alloy wire notwithstanding the difficulty of drawing alloy wires in a wire drawing process. Some representative prior art processing of metallic alloy wires is set forth in the following United States Patents.

U.S. Pat. No. 2,215,477 to Pipkin discloses a method of manufacturing wires of a relatively brittle metal which consists of assembling a rod of the metal within a tube of a relatively ductile metal to form therewith a composite single assembly. The assembly is successively drawn through a series of dies to thereby form a composite wire elements. A plurality of the wire elements are assembled within a tube of metal of the same character as that of the first-named tube to form therewith a composite multiple assembly. The multiple assembly is successively drawn through a series of dies to reduce the same to a predetermined diameter. The ductile metal is removed from the embedded wires of brittle metal.

U.S. Pat. No. 2,434,992 to Durst discloses an electrical contact comprising a length of a fine wire of valuable electrically conductive metal. The wire has a small cross-section and is encased in a sheath. The wire is mounted on an electrically conductive base in electrically conductive relation with respect thereto by means of an intermediate wire-supporting member of a non-valuable electrically conductive metal with the length of wire extending substantially parallel to and spaced outward from the base. The electrical outlet contact is formed by welding the sidewise periphery of a sheath for the wire of a non-valuable electrically conductive metal to the base and etching away all of the sheath except a portion intermediate the base and wire constituting the intermediate wire-supporting member. The base is formed of a metal which is resistant to etching by at least one etching agent which will etch the non-valuable metal of the sheath so that the base is not substantially etched away during the etching of the sheath.

U.S. Pat. No. 3,363,304 to Quinlan discloses exceedingly brittle zirconium-beryllium eutectic (about 5% Be by weight) made into a wire by enclosing it in a heavy stainless steel capsule and rotary swaging the assembly. The swaging is carried out at a temperature in the range 775-800 C. until the diameter has been reduced about 50%. The temperature is lowered to 700-735 C. for the remainder of the swaging. If wire rings are desired, the composite wire is wound on a mandrel while at its elevated temperature to form a helix. The stainless steel sheath is dissolved in sulfuric acid and the turns of the helix cut apart. A Zr—Be rod one half inch in diameter has been reduced to a wire 0.025 inch in diameter.

U.S. Pat. No. 3,394,213 to Roberts et al. discloses a method of forming fine filaments under approximately 15 microns in long lengths wherein a plurality of sheathed elements are firstly constricted to form a reduced diameter billet by means of hot forming the bundled filaments. After the hot forming constriction, the billet is then drawn to the final size wherein the filaments have the desired final small diameter. The material surrounding the filaments is then removed by suitable means leaving the filaments in the form of a tow.

U.S. Pat. No. 3,540,114 to Roberts et al. discloses a method of forming fine filaments formed of a material such as metal by multiple end drawing a plurality of elongated elements having thereon a thin film of lubricant material. The plurality of elements may be bundled in a tubular sheath formed of drawable material. The lubricant may be applied to the individual elements prior to the bundling thereof and may be provided by applying the lubricant to the elements while they are being individually drawn through a coating mechanism such as a drawing die. The lubricant comprises a material capable of forming a film having a high tenacity characteristic whereby the film is maintained under the extreme pressure conditions of the drawing process. Upon completion of the constricting operation, the tubular sheath is removed. If desired, the lubricant may also be removed from the resultant filaments.

U.S. Pat. No. 3,785,036 to Tada et al. discloses a method of producing fine metallic filaments by covering a bundle of a plurality of metallic wires with an outer tube metal and drawing the resultant composite wire. The outer tube metal on both sides of the final composite wire obtained after the drawing step is cut near to the core filaments present inside the outer tube and then both uncut surfaces of the composite wire are slightly rolled, thereby to divide the outer tube metal of the composite wire continuously and thus separating the outer tube metal from fine metallic filaments. The separation treatment can be effected by a simple apparatus within short time. This reduces the cost of production, and enables the outer tube metal to be recovered in situ.

U.S. Pat. No. 3,807,026 to Takeo et al. discloses a method of producing a yarn of fine metallic filaments at low cost, which comprises covering a bundle of a plurality of metal wires with an outer tube metal to form a composite wire. The composite wire is drawn and the outer tube metal is separated from the core filaments in the composite wire. The surfaces of the metal wires are coated with a suitable separator or subjected to a suitable surface treatment before the covering of the outer tube metal, thereby to prevent the metallic bonding of the core filaments to each other in the subsequent drawing or heat-treatment of the composite wire.

U.S. Pat. No. 3,838,488 to Tada et al. discloses an apparatus for producing fine metallic filaments which comprises supply means for supplying a drawn composite wire comprising a bundle of a plurality of metallic filaments surrounded by an outer metal tube. A cutting means comprising cutting bits is arranged symmetrically with respect to the composite wire in the cutting means for cutting and removing most of the outer metal tube of the composite wire on opposite sides of the metal tube. A rolling means comprises oppositely disposed rolls for pressing the uncut sides of the composite wire and to cause the composite wire to be compressed and spread outwardly in a direction perpendicular to the cut sides of the metal tube and for causing the metal tube to divide at the cut surface. A pickup means takes up the divided parts of the metal tube and the metallic filaments.

U.S. Pat. No. 3,848,319 to Hendrickson discloses the procedure for fabricating ultra-small precious metal or metal alloy wire comprising the steps of fabricating and annealing a copper sleeve with an axially aligned opening formed therein. A precious metal core is formed and inserted into the opening of the sleeve. The sleeve and the core have an outer dimensions preferably formed in the ratio of ten to one for mechanically binding the core to the sleeve to produce a bimetallic wire combination. The size of the wire combination is reduced on suitable wire drawing dies and the sleeve is chemically removed from the precious metal wire.

U.S. Pat. No. 3,943,619 to Hendrickson discloses a procedure for drawing ultrafine wires which incorporates the steps of inserting a core wire of a selected material into a plurality of telescoped sacrificial sheaths, welding the ends of the core wire to the sheath and successively drawing the combination down to a predetermined diameter. The outside sheath is sacrificed by etching to free the proportionately reduced core wire. The core wire may be initially covered with Teflon to aid in the reduction and the Teflon is removed by exposure to heat.

U.S. Pat. No. 3,977,070 to Schildbach discloses a method of forming a tow of filaments and the tow formed by the method wherein a bundle of elongated elements, such as rods or wires, is clad by forming a sheath of material different from that of the elements about the bundle and the bundle is subsequently drawn to constrict the elements to a desired small diameter. The elements may be formed of metal. The bundle may be annealed, or stress relieved, between drawing steps as desired. The sheath may be formed of metal and may have juxtaposed edges thereof welded together to retain the assembly. The sheath is removed from the final constricted bundle to free the filaments in the form of tow.

U.S. Pat. No. 4,044,447 to Hamada et al. discloses a number of wires gathered together and bound with an armoring material in the shape of a band. The wires in this condition are drawn by means of a wire drawing apparatus having dies and a capstan. A plurality of bundles of such wires are gathered together and bound in the same way as in the foregoing to form a composite bundle body, which is further drawn, and these processes are repeated until at least filaments of a specified diameter are obtained in quantities.

U.S. Pat. No. 4,209,122 to Hunt discloses a method of manufacturing wire described as alloy rods in an as cast condition and incorporated into a filled billet which is extruded within defined extrusion parameters to obtain a simultaneous reduction in the diameters of the cast rods. After separation from the filled billet, the extruded rods, now in wire form, are particularly suitable for manual welding applications of hard facing deposits. The separated alloy wires are joined by butt welding to form a wire of indeterminable length which is accurately sized by successive drawing and annealing steps, making it suitable for use with an automatic welding machine to weld hard facing deposits.

U.S. Pat. No. 4,323,186 to Hunt discloses a method for obtaining extrusion products of alloy wire of small cross section in an economical fashion. The ratio of length to cross section of cast alloy preforms limits the length of a filled billet to less than the optimum which may be extruded on available extrusion presses where it is desired to obtain small diameter extrusion products in a single extrusion. This limitation is overcome by squaring the ends of cast lengths of the alloy and then butt welding such lengths to compositely form preforms of the maximum length capable of being extruded on a given extrusion press. The composite preforms are extruded in a filled billet in accordance with the teaching of U.S. Pat. No. 4,209,122. The extrusion products from these composite preforms have the same desirable properties described in that patent and extend the benefits described therein.

U.S. Pat. No. 4,863,526 to Miyagawa et al. discloses a fine crystalline thin wire of a cobalt base alloy and a process of making having a composition of the formula CokMlBmSin where Co is cobalt; M is at least one of the transition metals of groups IV, V and VI of the periodic table; B is boron; Si is silicon; K, 1, m and n represent atom percent of Co, M, B and Si, respectively and the fine crystal grains in the thin wire having an average size of no more than 5 μm.

U.S. Pat. No. 5,266,279 to Haerle discloses a filter or catalyst body for removing harmful constituents from the waste gases of an internal combustion engine provided with at least one fabric layer of metal wires or metal fibers. Sintering material in the form of powder, granules, fiber fragments or chips is introduced into the meshes and is sintered on to the wires or fibers. The woven fabric is in the form of a twilled wire fabric, sintering material being introduced into the meshes thereof and being sintered together with the wires or fibers.

U.S. Pat. No. 5,505,757 to Ishii discloses a metal filter for a particulate trap which meets the requirements for low pressure drop, high collecting capacity and a long life. The metal filters have one or more layers of unwoven fabric (such as felt) formed of a metal fiber having one of the following alloy compositions A, B and C wherein composition A is made of Ni:5-20% by weights, Cr:10-40 by weights, Al:1-15% by weight, the remainder being Fe and inevitable impurities; composition B is made of Cr:10-40% by weight, Al:1-15% by weight, the remainder being Ni and inevitable impurities; and composition C is made of Cr:10-40% by weight, Al:1-15% by weight, the remainder being Fe and inevitable components. The metal filter is highly resistant to corrosion and heat and can withstand repeated heating for removal of the particulate.

U.S. Pat. No. 5,827,997 to Chung et al. discloses a material including filaments, which include a metal and an essentially coaxial core, each filament having a diameter less than 6 um, each core being essentially carbon, displays high effectiveness for shielding electromagnetic interference (EMI) when dispersed in a matrix to form a composite material. This matrix is selected from the group consisting of polymers, ceramics and polymer-ceramic combinations. This metal is selected from the group consisting of nickel, copper, cobalt, silver, gold, tin, zinc, nickel-based alloys, copper-based alloys, cobalt-based alloys, silver-based alloys, gold-based alloys, tin-based alloys and zinc-based alloys. The incorporation of 7 percent volume of this material in a matrix that is incapable of EMI shielding results in a composite that is substantially equal to copper in EMI shielding effectiveness at 1-2 GHz.

U.S. Pat. No. 5,830,415 to Maeda et al. discloses a car exhaust purifying filter member which is high in the capacity to collect solid and liquid contents in exhausts and which has such high heat resistance as to be capable of withstanding heat when burned for cleaning and a method of manufacturing the same. A three-dimensional mesh-like metallic porous member made from Ni—Cr—Al and having a three-dimensional frame-work is heated to 800-100 degrees C. in the atmosphere to form on its surface a densely grown fibrous alumina crystal. This member is used as a filter member. Such a filter member shows excellent collecting capacity and corrosion resistance and can withstand high temperatures. Also, it is possible to firmly carry a catalyst on the fibrous alumina crystal formed on the surface. Because of its increased surface area, it has an increased catalyst carrying capacity.

U.S. Pat. No. 5,863,311 to Nagai et al. discloses a particulate trap for a diesel engine use which is less likely to vibrate or deform under exhaust pressures and achieves good results in all of the particulate trapping properties, pressure drop, durability and regenerating properties. This trap has a filter element made of plurality of flat or cylindrical filters. Longitudinally extending exhaust incoming and outgoing spaces are defined alternately between the adjacent filters by alternately closing the inlet and outlet ends of the spaces between the adjacent filters. Gas permeable reinforcing members are inserted in the exhaust outgoing spaces to prevent the filter from being deformed due to the difference between the pressure upstream and downstream of each filter produced when exhausts pass through the filters. Similar gas permeable reinforcing members may also be inserted in the exhaust incoming spaces or at both ends of the filter element to more positively prevent vibration of the filters.

U.S. Pat. No. 5,890,272 to Liberman et al. discloses a process for making fine metallic fibers comprising coating a plurality of metallic wires with a coating material. The plurality of metallic wires are jacketed with a tube for providing a cladding. The cladding is drawn for reducing the outer diameter thereof The cladding is removed to provide a remainder comprising the coating material with the plurality of metallic wires contained therein. The remainder is drawn for reducing the diameter thereof and for reducing the corresponding diameter of the plurality of metallic wires contained therein. The coating material is removed for providing the plurality of fine metallic fibers.

U.S. Pat. No. 5,908,480 to Ban et al. discloses a particulate trap for use in a diesel engine which is inexpensive, and which is high in particulate trapping efficiency, regeneration properties and durability, and low in pressure loss due to particulates trapped. An even number of flat filters made from a non-woven fabric of heat-resistant metallic fiber are laminated alternately with the same number of corrugated sheets made of a heat-resistant metal. The laminate thus formed are rolled into a columnar shape. Each space between the adjacent flat filters in which every other corrugated sheet is inserted is closed at one end of the filter element by a closure member. The other spaces between the adjacent flat filters are closed at the other end of the filter element.

U.S. Pat. No. Re. 28,470 to Webber discloses a porous metal structure made from a plurality of relatively short fracture-free substantially non-straight rough surfaced metal fibers distributed in either a two-dimensional or a three-dimensional orientation. The fibers have preselected cross sections with the porous structure containing either uniform cross-section fibers or different cross-sectioned fibers. The fibers may be in a stress relieved condition or a cold worked condition. The porous metal structure fibers have a mean cross-sectional dimension of under approximately fifty microns and the fibers have an average length of at least approximately two inches.

Although small wires can be formed with metallic alloys, fine fibers formed from metallic alloys have heretofore not been formed due to the difficulty of drawing alloy wires into metallic alloy fine fibers in a wire drawing process.

Therefore, it is an object of the present invention to provide a fine fiber made from a metallic alloy and a new process for forming the fiber from a metallic alloy.

Another object of the present invention is to provide a fine fiber made from a metallic alloy and a new process for forming the fiber from a metallic alloy wherein the fine metallic alloy fiber has a diameter less than fifty microns.

Another object of the present invention is to provide a fine fiber made from a metallic alloy and a new process for forming the fiber from a metallic alloy which is capable of making a fine fiber made from a new metallic alloy.

Another object of the present invention is to provide a fine fiber made from a metallic alloy and a new process for forming the fiber from a metallic alloy having different surface properties.

Another object of the present invention is to provide a fine fiber made from a metallic alloy and a new process for forming the fiber from a metallic alloy that is economical to manufacture.

Another object of the present invention is to provide a fine fiber made from a metallic alloy and a new process for forming the fiber from a metallic alloy that is cost effective for producing fine fibers from a metallic alloy in commercial quantities.

The foregoing has outlined some of the more pertinent objects of the present invention. These objects should be construed as being merely illustrative of some of the more prominent features and applications of the invention. Many other beneficial results can be obtained by applying the disclosed invention in a different manner or modifying the invention with in the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention relates to a process for making a fine metallic alloy fiber comprising the steps of encompassing a metallic alloy wire with a cladding material. The cladding material is tightened about the metallic alloy wire in the presence of an inert atmosphere to provide a cladding. The cladding is drawn for reducing the outer diameter thereof and for reducing the diameter of the metallic alloy wire to provide a fine metallic alloy fiber from the metallic alloy wires. The cladding material is removed from the fine metallic alloy fiber.

In a more specific example of the invention, the step of tightening the cladding material about the metallic alloy wire comprises tightening the cladding material about the metallic alloy wire in the presence of an inert atmosphere located between the cladding material and the metallic alloy wire. The step of drawing the cladding includes successively drawing and successively annealing the cladding at a temperature between 1650° F. and 2050° F. and rapidly cooling the cladding in a heat conducting fluid after the annealing process.

In another example of the invention, the process includes assembling a multiplicity of the drawn claddings within a second cladding material to form a second cladding. The second cladding are drawn for reducing the diameter thereof and for providing a multiplicity of fine metallic alloy fibers from the multiplicity of metallic alloy wires. The cladding materials are removed for providing a multiplicity of fine metallic alloy fibers.

In another example of the invention, the process includes providing a metallic alloy wire formed from a first and a second alloy component with the cladding material being formed from one of the first and second alloy components. The metallic alloy wire encompassed with the cladding material to provide a cladding. The cladding is drawn for reducing the outer diameter thereof and for reducing the diameter of the metallic alloy wire to provide a drawn cladding having a fine metallic alloy fiber formed from the metallic alloy wire. The drawn cladding is heated to a temperature sufficient for annealing the drawn cladding with minimal diffusion of the cladding material into the fine metallic alloy fiber. The cladding material is removed from the fine metallic alloy fiber and the fine metallic alloy fiber is heated to a temperature sufficient to further diffuse the minimal diffused cladding material into the metallic alloy fiber to provide a substantially homogeneous fine metallic alloy fiber.

In another example of the invention, the cladding material is formed from a material different from the first and second alloy components. The cladding is drawn for reducing the outer diameter thereof and for reducing the diameter of the metallic alloy wire to provide a drawn cladding having a fine metallic alloy fiber formed from the metallic alloy wire. The drawn cladding is heated to a temperature sufficient for annealing the drawn cladding and for diffusing the cladding material into the metallic alloy fiber. The cladding material is removed from the fine metallic alloy fiber. The fine metallic alloy fiber is heated to a temperature sufficient to further diffuse the diffused cladding material into the metallic alloy fiber to provide a fiber formed from a new alloy comprising the first and second alloy component and the diffused cladding material.

In another example of the invention, the cladding material is formed from a material different from the first and second alloy components. The drawn cladding is heated to a temperature sufficient for annealing the drawn cladding and for diffusing the cladding material into the surface of the metallic alloy fiber. The cladding material is removed for providing a fine metallic alloy fiber having surface properties in accordance with the properties of the cladding material.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is a block diagram of a first process for making fine metallic alloy fibers of the present invention;

FIG. 2 is an isometric view of a metallic alloy wire referred to in FIG. 1;

FIG. 2A is an end view of FIG. 2;

FIG. 3 is an isometric view illustrating a preformed first cladding material referred to in FIG. 1;

FIG. 3A is an end view of FIG. 3;

FIG. 4 is an isometric view illustrating the first cladding material of FIG. 3 encompassing the metallic alloy wire of FIG. 2;

FIG. 4A is an end view of FIG. 4;

FIG. 5 is an isometric view similar to FIG. 4 illustrating the first cladding material being sealed to the metallic alloy wire;

FIG. 5A is an end view of FIG. 5;

FIG. 6 is an isometric view similar to FIG. 5 illustrating the tightening of the first cladding material to the metallic alloy wire in the presence of an inert atmosphere;

FIG. 6A is an end view of FIG. 6;

FIG. 7 is an isometric view similar to FIG. 6 illustrating the first cladding material tightened to the metallic alloy wire;

FIG. 7A is an end view of FIG. 7;

FIG. 8 is an isometric view of the first cladding of FIG. 7 after a first drawing process;

FIG. 8A is an enlarged end view of FIG. 8;

FIG. 9 is an isometric view illustrating an assembly of a multiplicity of the drawn first claddings within a second cladding;

FIG. 9A is an end view of FIG. 9;

FIG. 10 is an isometric view of the second cladding of FIG. 9 after a second drawing process;

FIG. 10A is an enlarged end view of FIG. 10;

FIG. 11 is an isometric view similar to FIG. 10 illustrating the removal of the first and second claddings to provide a multiplicity of fine metallic alloy fibers;

FIG. 11A is an enlarged end view of FIG. 11;

FIG. 12 is a block diagram of a second process for making a fine metallic alloy fiber of the present invention;

FIG. 13 is an isometric view of a metallic alloy wire referred to in FIG. 12;

FIG. 13A is an end view of FIG. 13;

FIG. 14 is an isometric view illustrating a preformed cladding material referred to in FIG. 12;

FIG. 14A is an end view of FIG. 14;

FIG. 15 is an isometric view illustrating the cladding material of FIG. 14 tightened on the metallic alloy wire of FIG. 13;

FIG. 15A is an end view of FIG. 15;

FIG. 16 is an isometric view of the cladding of FIG. 15 after a drawing process;

FIG. 16A is an enlarged end view of FIG. 16;

FIG. 17 is an isometric view similar to FIG. 16 illustrating the removal of the cladding material to provide a fine metallic alloy fiber;

FIG. 17A is an enlarged end view of FIG. 17;

FIG. 18 is a magnified view of FIG. 17A illustrating an enhanced concentration of diffused cladding material at the periphery of the fine metallic alloy fiber;

FIG. 19 is a view similar to FIG. 18 illustrating a homogeneous concentration of the diffused cladding material within the fine metallic alloy fiber;

FIG. 20 is a photograph of the energy dispersive X-ray spectra illustrating the enhanced concentration of diffused cladding material at the periphery of the fine metallic alloy fiber of FIG. 18;

FIG. 21 is a photograph of the energy dispersive X-ray spectra illustrating the homogeneous concentration of the diffused cladding material within the fine metallic alloy fiber of FIG. 19;

FIG. 22 is a block diagram of a third process for making a fine metallic alloy fiber of the present invention;

FIG. 23 is an isometric view of a metallic alloy wire referred to in FIG. 22;

FIG. 23A is an end view of FIG. 23;

FIG. 24 is an isometric view illustrating the forming of a cladding material about the metallic alloy wire referred to in FIG. 22;

FIG. 24A is an end view of FIG. 24;

FIG. 25 is an isometric view illustrating the cladding material of FIG. 24 encompassing the metallic alloy wire of FIG. 23;

FIG. 25A is an end view of FIG. 25;

FIG. 26 is an isometric view of the cladding of FIG. 25 after a drawing process;

FIG. 26A is an enlarged end view of FIG. 26;

FIG. 27 is an isometric view similar to FIG. 26 illustrating the removal of the cladding material to provide a fine metallic alloy fiber;

FIG. 27A is an enlarged end view of FIG. 27;

FIG. 28 is a magnified view of FIG. 27A illustrating an enhanced concentration of diffused cladding material at the periphery of the fine metallic alloy fiber;

FIG. 29 is a view similar to FIG. 28 illustrating a homogeneous concentration of the diffused cladding material within the fine metallic alloy fiber for providing a new alloy;

FIG. 30 is a block diagram of a fourth process for making a fine metallic alloy fiber of the present invention;

FIG. 31 is an isometric view of a metallic alloy wire referred to in FIG. 30;

FIG. 31A is an end view of FIG. 31;

FIG. 32 is an isometric view illustrating an electroplating of a cladding material about the metallic alloy wire referred to in FIG. 31;

FIG. 32A is an end view of FIG. 32;

FIG. 33 is an isometric view of the cladding of FIG. 32 after a drawing process;

FIG. 33A is an enlarged end view of FIG. 33;

FIG. 34 is an isometric view similar to FIG. 33 illustrating the removal of the cladding material to provide a fine metallic alloy fiber;

FIG. 34A is an enlarged end view of FIG. 34; and

FIG. 35 is a magnified view of FIG. 34A illustrating an enhanced concentration of diffused cladding material at the periphery of the fine metallic alloy fiber for providing a fine metallic alloy fiber having surface properties in accordance with the properties of the cladding material.

Similar reference characters refer to similar parts throughout the several Figures of the drawings.

### DETAILED DISCUSSION

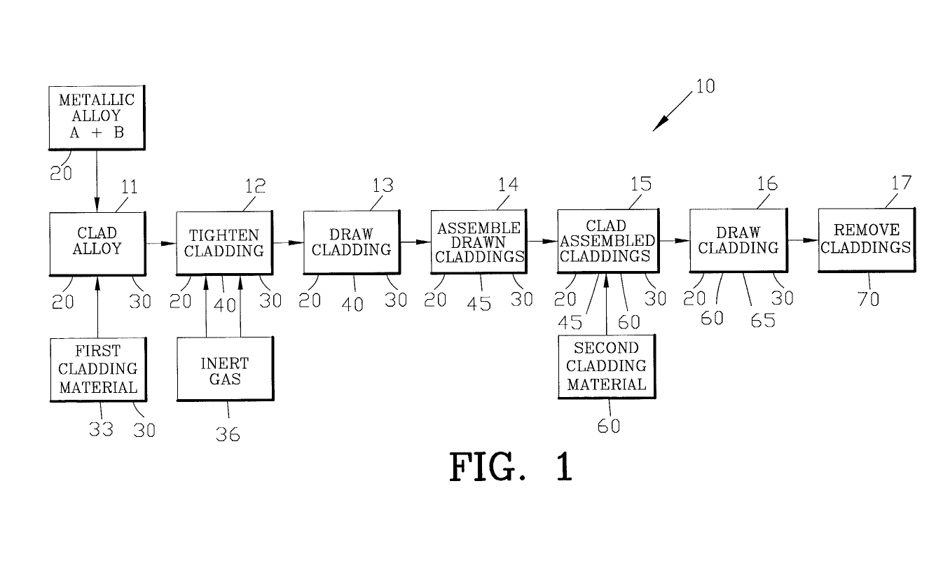

FIG. 1 is a block diagram illustrating a first embodiment of an improved process 10 for making a fine metallic alloy fiber. In this embodiment of the invention, the improved process 10 is capable of simultaneously making a multiplicity of fine metallic alloy fibers. The first embodiment of the improved process 10 is capable of simultaneously making thousands of individual metallic alloy fibers with each of the fine metallic alloy fibers having a diameter less than 10 micrometers. The improved process 10 of FIG. 1 utilizes a metallic alloy 20 and a cladding material. The metallic alloy 20 is shown being formed from a first alloy component (A) and a second alloy component (B).

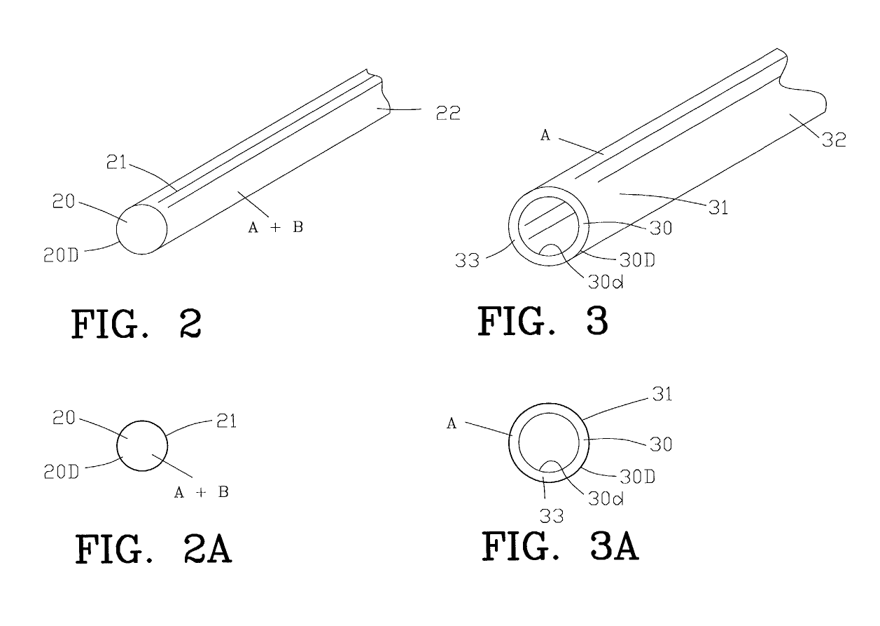

FIG. 2 is an isometric view of the metallic alloy wire 20 referred to in FIG. 1 with FIG. 2A being an end view of FIG. 2. The metallic alloy wire 20 extends between a first end 21 and a second end 22. The metallic alloy wire 20 defines an outer diameter 20D. The metallic alloy 20 is shown being formed from the first alloy component (A) and the second alloy component (B) to be representative of the two alloy components of a selected two alloy component alloy material. Although the metallic alloy 20 is disclosed as a metallic alloy having two components, it should be appreciated that the metallic alloy 20 may have any number of components as set forth in TABLE I. Preferably, the metallic alloy 20 is in the form of a wire or a similar configuration.

The process 10 of the present invention has been found to work with various types of metallic alloys. In one example of the invention, the metallic alloy wire 20 is selected from the group consisting of Haynes C-22, Haynes C-2000, Haynes HR-120, Haynes HR-160, Haynes 188, Haynes 556, Haynes 214, Haynes 230, Fecralloy Hoskins 875, Fecralloy M, Fecralloy 27-7 and HAST X. The chemical composition of this group of metallic alloys is given in TABLE 1.

TABLE I
CHEMICAL COMPOSITION OF METALLIC ALLOYS

| HAYNES | WEIGHT PERCENT | | | | | | | | | | |
|---|---|---|---|---|---|---|---|---|---|---|---|
| ALLOYS | Ni | Co | Fe | Cr | Mo | W | Mn | Si | C | La | Others |
| C-22 | 56 | 2.5 | 3 | 22 | 13 | 3 | 0.5 | 0.08 | 0.01 | — | 0.035 V |
| C-2000 | 59 | — | — | 23 | 16 | — | — | 0.08 | 0.01 | — | 1.6 Cu |
| HR-120 | 37 | 3 | 33 | 25 | 2.5 | 2.5 | 0.7 | 0.6 | 0.05 | — | 0.7 Cb,0.2 Al |
| HR-160 | 37 | 30 | 3.5 | 28 | 1.0 | 1.0 | 0.5 | 2.75 | 0.05 | — | 1.0 Cb |
| 188 | 22 | 39 | 3 | 22 | — | 14 | 1.25 | 0.35 | 0.10 | 0.03 | |
| 556 | 20 | 18 | 31 | 22 | 3 | 2.5 | 1 | 0.4 | 0.10 | 0.02 | 0.6 Ta, 0.2 Al,N |
| 214 | 75 | — | 3 | 16 | — | — | 0.5 | 0.2 | 0.05 | — | 4.5 Al, 0.01Y |
| 230 | 57 | 5 | 3 | 22 | 2 | 14 | 0.5 | 0.4 | 0.10 | 0.02 | 0.3 Al |
| HAST X | 47 | 1.5 | 18 | 22 | 9 | 0.6 | 1 | 1 | 0.10 | — | 0.008B |
| FECRALLOY | — | — | Bal. | 22.5 | — | — | — | 0.5 | 0.10 | — | 5.5 Al, 0.01Y |
| HOSKINS 875 | | | | | | | | | | | |
| FECRALLOY | — | — | Bal. | 27 | 2 | — | — | — | — | — | 7 Al, 0.15 RE |
| M | | | | | | | | | | | |

Although the process 10 of the present invention has been found useful in forming a fine metallic fiber from a metallic alloy as set forth in TABLE I, it should be understood that the process 10 of the present invention may be used with various other types of metallic alloys.

FIG. 3 is an isometric view illustrating a first cladding material 30 referred to in FIG. 1. The first cladding material 30 extends between a first and a second end 31 and 32. In this example of the process 10 of the present invention, the first cladding material 30 is shown as a preformed tube 33 having an outer diameter 30D and an inner diameter 30d.

FIG. 3A is an enlarged end view of FIG. 3. The inner diameter 30d of the preformed tube 33 of the first cladding material 30 is dimensioned to slidably receive the outer diameter 20D of the metallic alloy wire 20.

The first cladding material 30 is made of a material which is suitable for use with the selected metallic alloy 20. The first cladding material 30 may be formed from one of the first alloy component (A) and the second alloy component (B). In this specific example of the invention, the first cladding material 30 is shown as being formed from the first alloy component (A).

In the alternative, the first cladding material 30 is made of other materials which are suitable for use with the selected metallic alloy 20. In one example of the process 10, the first cladding material 30 is selected from the group including low carbon steel, copper, pure nickel and Monel 400 alloy. Although the above group of materials has been found useful for the first cladding material 30, it should be understood that the process 10 of the present invention should not be limited to the specific examples of materials set forth herein.

FIG. 1 illustrates the process step 11 of cladding the metallic alloy wire 20 with the first cladding material 30. In this example of the invention, the metallic alloy wire 20 is inserted into the preformed tube 33 of the first cladding material 30.

FIG. 4 is an isometric view similar to FIG. 3 illustrating the first cladding material 30 encompassing the metallic alloy wire 20. The inner diameter 30d of the preformed tube 33 of the first cladding material 30 slidably receives the outer diameter 20D of the metallic alloy wire 20. The first end 31 of the first cladding material 30 overlies the first end 21 of the metallic alloy wire 20.

FIG. 4A is an enlarged end view of FIG. 4. The difference between the inner diameter 30d of the preformed tube 33 and the outer diameter 20D of the metallic alloy wire 20 creates a space 34 therebetween. Preferably, the space 34 is minimized but is sufficient to enable insertion of the metallic alloy wire 20 within the first cladding material 30.

FIG. 1 illustrates the process step 12 of tightening the first cladding material 30 about the metallic alloy wire 20. In this example of the invention, the preformed tube 33 of the first cladding material 30 is tightened about the metallic alloy wire 20 in the presence of an inert gas 36.

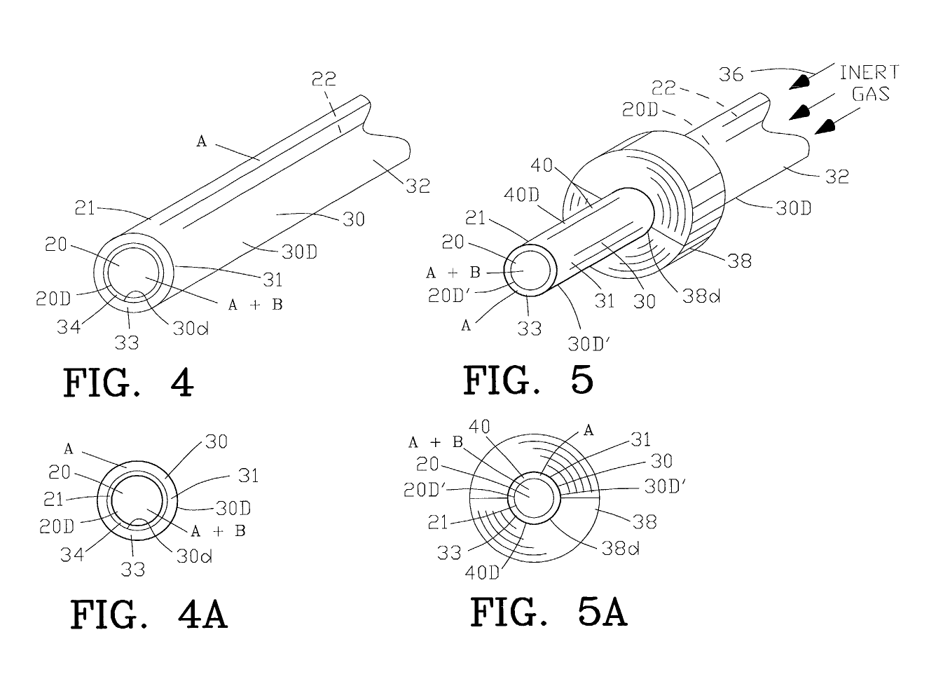

FIG. 5 is an isometric view similar to FIG. 4 illustrating the first cladding material 30 being sealed to the metallic alloy wire 20. Preferably, the preformed tube 33 of the first cladding material 30 is sealed to the metallic alloy wire 20 in the presence of the inert gas 36.

FIG. 5A is an enlarged end view of FIG. 5. A reducing die 38 seals the first end 31 of the first cladding material 30 to the first end 21 of the metallic alloy wire 20. More specifically, the reducing die has an inner diameter 38d that is smaller than the outer diameter 30D of the first cladding material 30 and is smaller than the outer diameter 20D of the metallic alloy wire 20. The reducing die 38 reduces the first cladding material 30 and the metallic alloy wire 20 therein to have a reduced outer diameter of 30D′ at the first end 31.

The insert gas 36 is injected into the space 34 between the inner diameter 30d of the pre-formed tube 33 and the outer diameter 20D of the metallic alloy wire 20 from the second end 32 of the first cladding material 30. The inert gas 36 purges the space 34 of ambient atmosphere and completely fills the space 34 with the inert gas 36. In one example of the invention, the inert gas 36 is selected from the group VIIIA of the Periodic table. In many cases, the inert gas 36 is selected from the group VIIIA of the Periodic table on the basis of economy, such as argon, helium or neon.

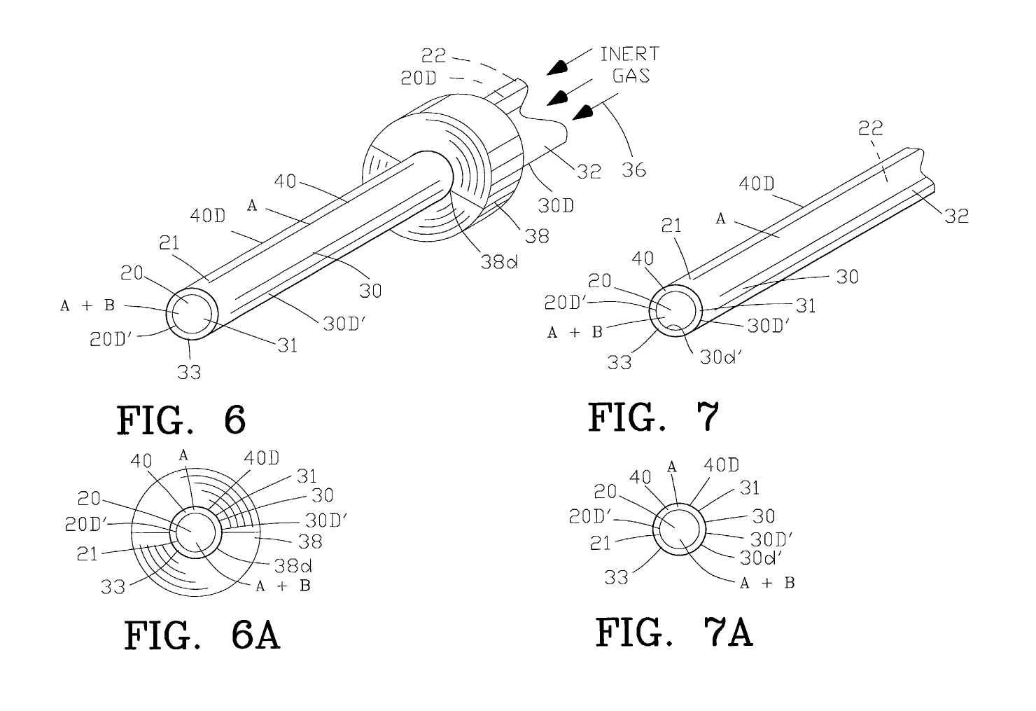

FIG. 6 is an isometric view similar to FIG. 5 illustrating the tightening of the first cladding material 30 to the metallic alloy wire 20 in the presence of the insert gas 36. After the space 34 is purged with the inert gas 36, the remainder of the first cladding material 30 is tightened onto the metallic alloy wire 20 up to the second end 32 of the first cladding material 30. The inert gas 36 insures that there is no reactive gas is interposed between the metallic alloy wire 20 and the first cladding material 30.

FIG. 6A is an enlarged end view of FIG. 6. As the first cladding material 30 is tightened against the metallic alloy wire 20 from the first end 31 to the second end 32, most of the inert gas 36 is squeezed from the space 34 between the metallic alloy wire 20 and the first cladding material 30. After the first cladding material 30 is tightened against the metallic alloy wire 20, the combination forms a first cladding 40 having an outer diameter 40D.

FIG. 7 is an isometric view similar to FIG. 6 illustrating the first cladding material 30 tightened to the metallic alloy wire 20. The metallic alloy wire 20 has a reduced outer diameter 20D′ whereas the first cladding material 30 has a reduced outer and inner diameter 30D′ and 30d′, respectively. The first cladding 40 has an outer diameter 40D.

FIG. 7A is an enlarged end view of FIG. 7. The first cladding material 30 is shown tightened onto the metallic alloy wire 20. Any minute voids between the between the metallic alloy wire 20 and the first cladding material 30 are filled with the inert gas 36.

FIG. 1 illustrates the process step 13 of drawing the first cladding 40 for reducing the outer diameter 40D thereof and for reducing the diameter 20D′ of the metallic alloy wire 20 within the first cladding 40 to provide a drawn first cladding 45.

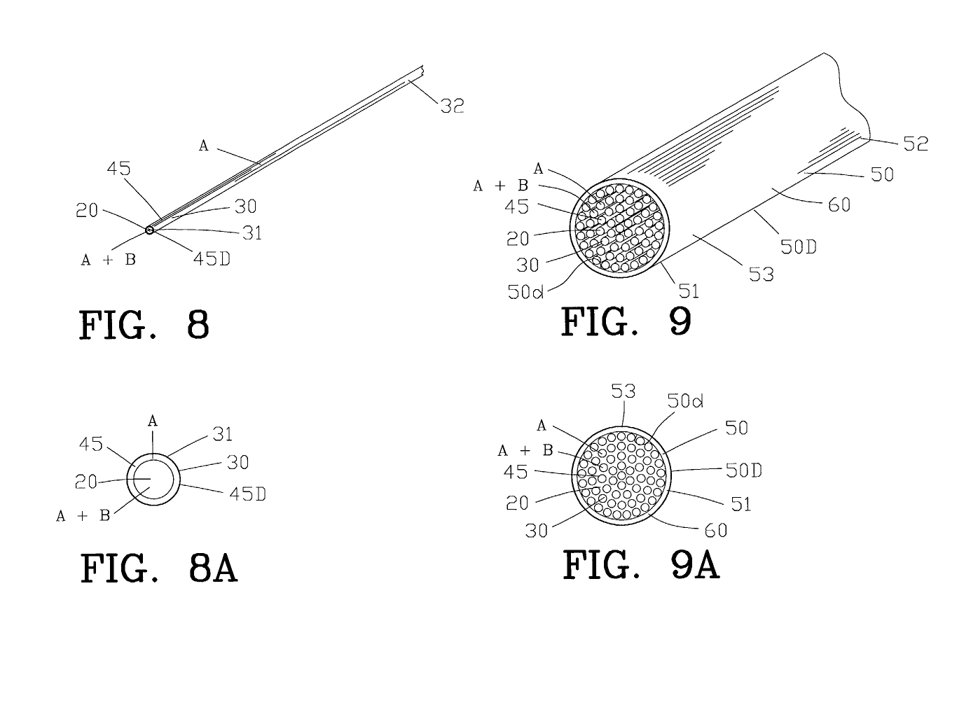

FIG. 8 is an isometric view of the first cladding 40 of FIG. 7 after a first drawing process 13 to provide the drawn first cladding 45. The drawn first cladding 45 defines an outer diameter 45D. The outer diameter 20D of the metallic alloy wire 20 is correspondingly reduced during the first drawing process 13.

FIG. 8A is an enlarged end view of FIG. 8. Preferably, the first drawing process 13 includes successively drawing the first cladding 40 followed by successive annealing of the first cladding 40. In the preferred form of the invention, the annealing of the first cladding 40 takes place within a specialized atmosphere such as a reducing atmosphere.

In the best mode of carrying out the invention, the first cladding 40 is rapidly heated within the reducing atmosphere. In one example of the invention, a mixture of hydrogen gas and nitrogen gas is used as the reducing atmosphere during the annealing of the first cladding 40. The first cladding 40 may be heated rapidly by a conventional furnace or may be heated rapidly by infrared heating or induction heating. The annealing may be accomplished in either a batch process or a continuous process.

Preferably, the annealed first cladding 40 is rapidly cooled within the heat conducting fluid. Tthe first cladding 40 may be cooled rapidly by a quenching annealed first cladding 40 in a high thermoconductive fluid. The high thermoconductive fluid may be a liquid such as water or oil or a high thermoconductive gas such a hydrogen gas. In one example, the thermoconductive gas comprises twenty percent (20%) to one hundred percent (100%) hydrogen. to rapidly cool the first cladding 40.

FIG. 1 illustrates the process step 14 of assembling a multiplicity of the drawn first claddings 45. Typically, 400 to 1000 of the drawn first claddings 45 are assembled with the process 10 of the present invention.

FIG. 1 illustrates the process step 15 of cladding the assembly of the multiplicity of the drawn first claddings 45 within a second cladding 50. The quantity of 400 to 1000 of the drawn first claddings 45 are assembled within the second cladding 50.

FIG. 9 is an isometric view illustrating the assembly of a multiplicity of the drawn first claddings 45 within the second cladding 50. The second cladding 50 extends between a first end 51 and a second end 52.

FIG. 9A is an enlarged end view of FIG. 9. In this example, the second cladding 50 is shown as a preformed tube 53 having an outer diameter 50D and an inner diameter 50d. In the alternative, the second cladding 50 may be formed about the assembly of a multiplicity of the drawn first claddings 45. The second cladding 50 is formed from a second cladding material 60 which is suitable for use with the selected metallic alloy wire 20. In addition, the second cladding material 60 is made of a material which is suitable for use with the selected first cladding material 30. In one example, the second cladding material 60 is selected from the group consisting of low carbon steel, copper, pure nickel and Monel 400 alloy. Although the above group of the materials has been found useful for the second cladding material 60, it should be understood that the process 10 of the present invention may be used with various other types of materials for the second cladding material 60.

FIG. 1 illustrates the process step 16 of drawing the second cladding 50 for reducing the outer diameter 50D thereof. The second drawing process 16 reduces the diameter 45D of the drawn first claddings 45 and the metallic alloy wire 20 within the second cladding 50 to provide a drawn second cladding 65.

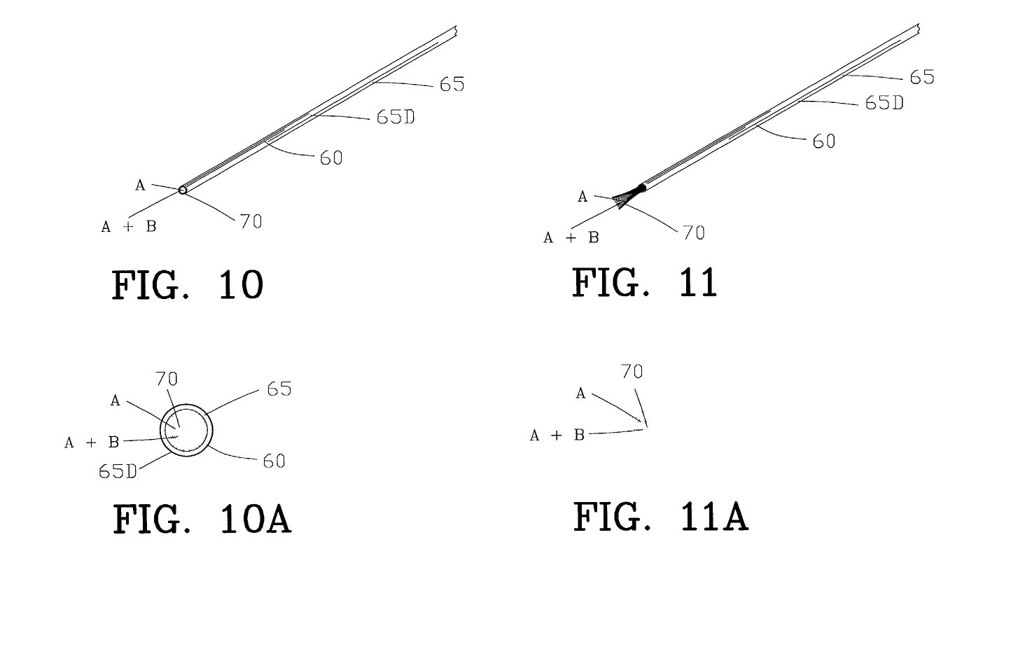

FIG. 10 is an isometric view of the second cladding 50 of FIG. 9 after a second drawing process 16 to provide the drawn second cladding 65. The drawn second cladding 65 defines an outer diameter 65D. The outer diameter 20D of the metallic alloy wire 20 is correspondingly reduced during the second drawing process 16. The drawing of the second cladding 50 transforms the multiplicity of metallic alloy wires 20 into a multiplicity of fine metallic alloy fibers 70.

FIG. 10A is an enlarged end view of FIG. 10. Preferably, the second drawing process 16 includes successively drawing the second cladding 50 followed by successive annealing of the second cladding 50. In the preferred form of the invention, the annealing of the second cladding 50 takes place within a specialized atmosphere such as a reducing atmosphere as set forth above.

FIG. 1 illustrates the process step 17 of removing the first and second cladding materials 30 and 60 from the multiplicity of fine metallic alloy fibers 70. Preferably, the first and second cladding materials 30 and 60 are removed from the multiplicity of fine metallic alloy fibers 70 by a chemical or an electrochemical process.

FIG. 11 is an isometric view similar to FIG. 10 illustrating the removal of the first and second claddings 30 and 60. The removal of the first and second claddings 30 and 60 provides a multiplicity of fine metallic alloy fibers 70. The process step 17 of removing the first and second cladding materials 30 and 60 from the multiplicity of fine metallic alloy fibers 70 may include leaching the first and second drawn claddings 45 and 65 for chemically removing the first and second cladding materials 30 and 60.

FIG. 11A is an enlarged end view of FIG. 11. The multiplicity of fine metallic alloy fibers 70 may contain thousands of individual metallic alloy fibers 70. Each of the fine metallic alloy fibers 70 may have a diameter less than 10 micrometers.

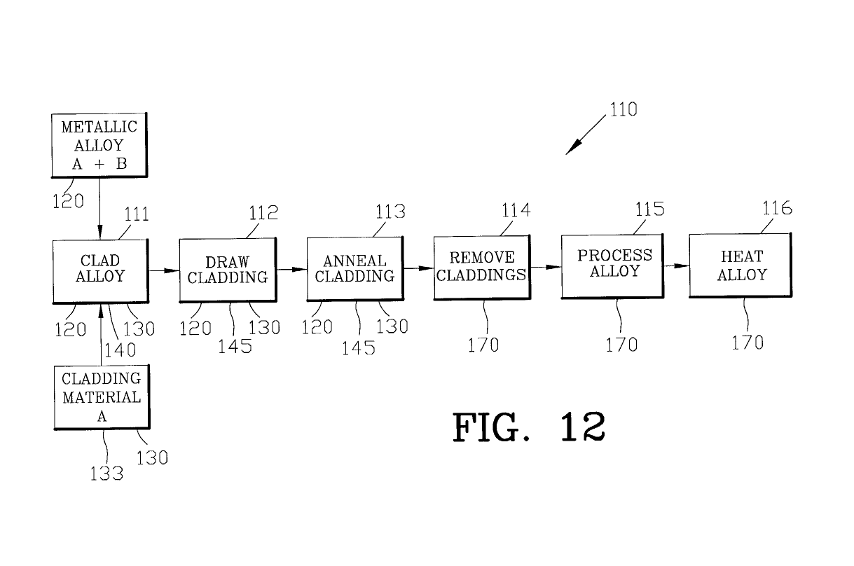

FIG. 12 is a block diagram of a second embodiment of an improved process 110 for making a fine metallic alloy fiber of the present invention. The second embodiment of the improved process 110 will be explained with reference to making a single fine metallic alloy fiber. However, it should be understood that the second improved process 110 may be modified to produce a multiplicity of fine metallic alloy fibers in a manner similar to the first process 10 shown in FIGS. 1-11.

The improved process 110 of FIG. 12 utilizes a metallic alloy 120 and a cladding material 130. The metallic alloy 120 is shown being formed from a first alloy component (A) and a second alloy component (B).

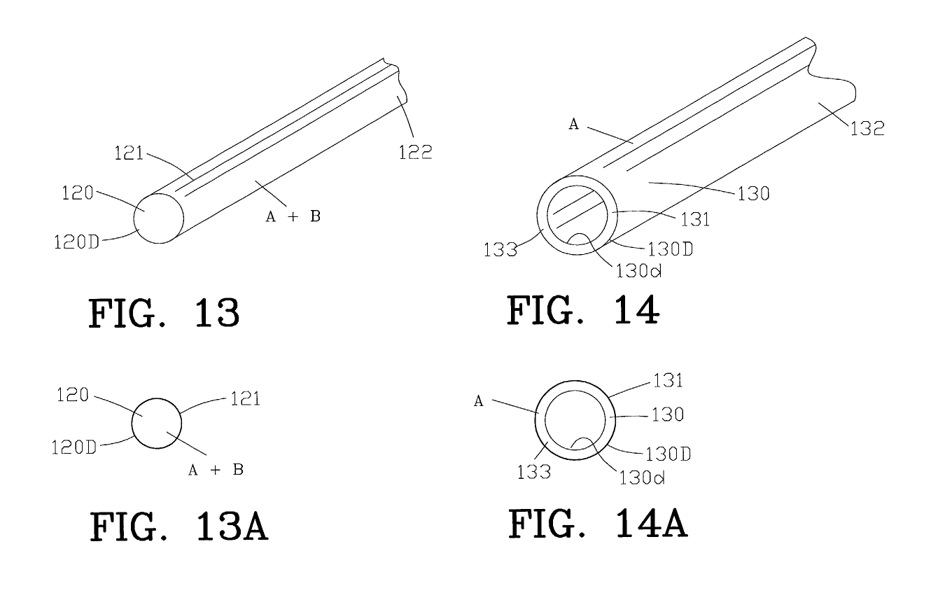

FIG. 13 is an isometric view of the metallic alloy wire 120 referred to in FIG. 12 with FIG. 13A being an end view of FIG. 13. The metallic alloy wire 120 extends between a first end 121 and a second end 122 and defines an outer diameter 120D. The metallic alloy 20 is shown being formed from the first alloy component (A) and the second alloy component (B) but it should be appreciated that the metallic alloy 120 may have any number of components as set forth in TABLE I.

FIG. 14 is an isometric view illustrating a cladding material 130 referred to in FIG. 12. The cladding material 130 extends between a first and a second end 131 and 132 and is shown as a pre-formed tube 133 having an outer diameter 130D and an inner diameter 130d.

FIG. 14A is an enlarged end view of FIG. 14. The inner diameter 130d of the preformed tube 133 of the cladding material 130 is dimensioned to slidably receive the outer diameter 120D of the metallic alloy wire 120 as previously set forth.

The cladding material 130 is made of a material that is compatable with the selected metallic alloy 120. The cladding material 130 is formed from one of the first alloy component (A) and the second alloy component (B). In this specific example of the invention, the cladding material 130 is shown as being formed from the first alloy component (A).

FIG. 12 illustrates the process step 111 of cladding the metallic alloy wire 120 with the cladding material 130. The metallic alloy wire 120 is inserted into the preformed tube 133 of the cladding material 130.

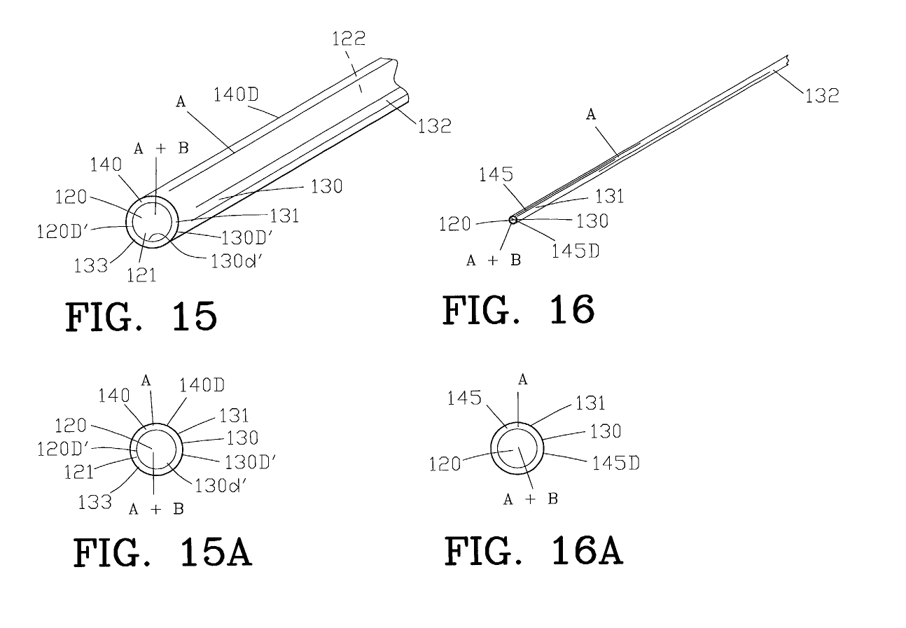

FIG. 15 is an isometric view similar to FIG. 14 illustrating the cladding material 130 encompassing the metallic alloy wire 120. The inner diameter 130d of the preformed tube 133 of the cladding material 130 slidably receives the outer diameter 120D of the metallic alloy wire 120. The first end 131 of the cladding material 130 overlies the first end 121 of the metallic alloy wire 120.

FIG. 15A is an enlarged end view of FIG. 15. Preferably, the cladding material 130 is tightened about the metallic alloy wire 120 in the presence of an inert gas as heretofore described. The cladding material 130 is tightened onto the metallic alloy wire 120 to have a reduced outer diameter of 130D′. After the cladding material 130 is tightened against the metallic alloy wire 120, the combination forms a cladding 140 having an outer diameter 140D.

FIG. 12 illustrates the process step 112 of drawing the cladding 140 for reducing the outer diameter 140D thereof and for reducing the diameter 120D′ of the metallic alloy wire 120 within the cladding 140 to provide a drawn cladding 145 having a outer diameter 145D.

FIG. 12 illustrates the process step 113 of annealing the drawn the cladding 140. Preferably the drawing process 112 and the annealing process 113 of FIG. 12 are interrelated to include the successive drawing and the successive annealing of the cladding 145. The time and temperature of the annealing process 113 is established to control the diffusion of the clad material 130 into the metallic alloy wire 120.

Preferably, the annealing of the cladding 145 takes place within a specialized atmosphere such as a reducing atmosphere. In the best mode of carrying out the invention, the cladding 145 is rapidly heated within the reducing atmosphere to a temperature between 1650° F. and 2050° F.

In one example of the invention, a mixture of hydrogen gas and nitrogen gas is used as the reducing atmosphere during the annealing of the cladding 14. The cladding 145 may be heated rapidly by a conventional furnace or may be heated rapidly by infrared heating or induction heating.

Preferably, the annealed cladding 145 is rapidly cooled within the heat conducting fluid. The cladding 145 may be cooled rapidly by a quenching annealed cladding 145 in a high thermoconductive fluid. The high thermoconductive fluid may be a liquid such as water or oil or a high thermoconductive gas such a hydrogen gas. In one example, the thermoconductive gas comprises twenty percent (20%) to one hundred percent (100%) hydrogen to rapidly cool the cladding 140.

FIG. 16 is an isometric view of the cladding 145 of FIG. 15 after the drawing process 112 and the annealing process 113 to provide the drawn cladding 145. The drawn cladding 145 defines an outer diameter 145D. The outer diameter 120D of the metallic alloy wire 120 is correspondingly reduced in the drawing process. The drawing of the cladding 145 transforms the metallic alloy wire 120 into a fine metallic alloy fiber 170.

FIG. 12 illustrates the process step 114 of removing the cladding material 130 from the fine metallic alloy fiber 170. Preferably, the cladding material 130 is removed from the fine metallic alloy fiber 170 by a chemical or an electrochemical process.

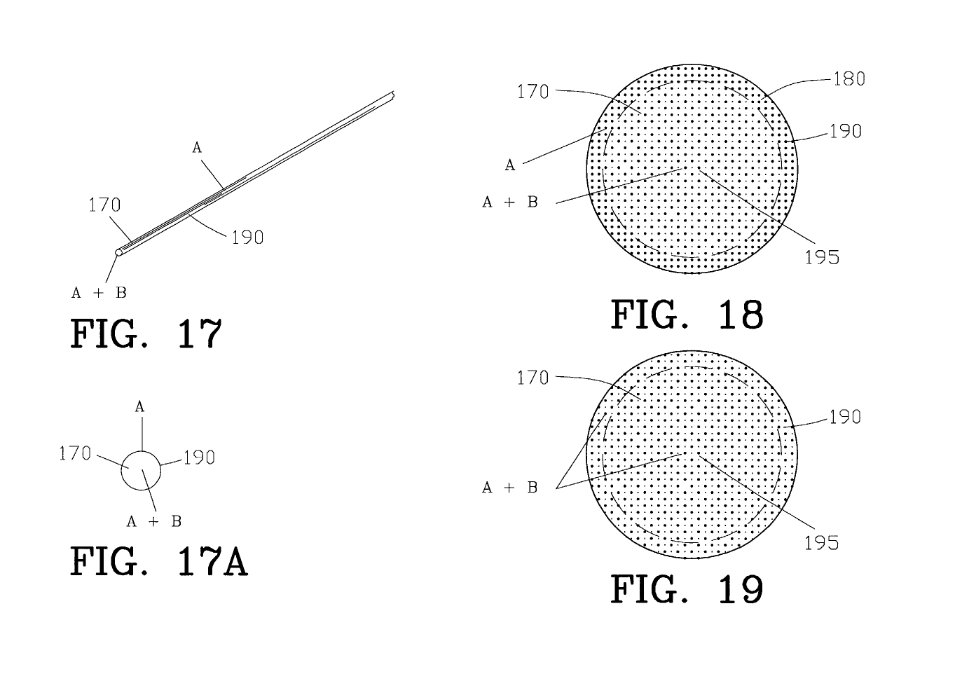

FIG. 17 is an isometric view similar to FIG. 16 illustrating the removal of the cladding material 130 to provide a fine metallic alloy fiber 170. The process step 114 of removing the cladding material 130 from the fine metallic alloy fiber 170 may include leaching the drawn cladding 145 for chemically removing the cladding material 130.

FIG. 17A is an enlarged end view of FIG. 17 illustrating the cross-section of the fine metallic alloy fiber 170. A portion of the clad material 130 has diffused into the metallic alloy fiber 170 during the annealing process. The diffused clad material 130 provides an enhanced concentration 180 of the clad material 130 at the periphery 190 of the fine metallic alloy fiber 170.

FIG. 12 illustrates the process step 115 of processing the fine metallic alloy fiber 170. The fine metallic alloy fiber 170 may be used for a wide variety of intents and purposes. It should be appreciated by those skilled in the art that the present invention should not be limited by the intended use of the fine metallic alloy fiber 170.

In one example, the fine metallic alloy fiber 170 may be used to make fiber tow for high temperature and/or high corrosive applications. In another example, the fine metallic alloy fiber 170 may be used to make metallic filters as described in U.S. Pat. No. 4,126,566. In a further example, the fine metallic alloy fiber 170 may be used to make metallic membranes. In still a further example, the fine metallic alloy fiber 170 may be used to make catalyst carriers.

FIG. 18 is a magnified view of FIG. 17A illustrating the enhanced concentration 180 of diffused cladding material 130 at the periphery 190 of the fine metallic alloy fiber 170. During the annealing of the cladding 140, a portion of the cladding material 130 has migrated or diffused into the periphery 190 of the fine metallic alloy fiber 170.

A portion of the first alloy component (A) of the cladding material 130 has migrated or diffused into the periphery 190 of the fine metallic alloy fiber 170. The migration or diffusion of the first alloy component (A) of the cladding material 130 results in an excess of the first alloy component (A) relative to the amounts of the first alloy component (A) and the second alloy component (B) in a central region 195 of the fine metallic alloy fiber 170.

FIG. 12 illustrates the process step 116 of heating the fine metallic alloy fiber 170. The process step 116 of heating the fine metallic alloy fiber 170 may be undertaken simultaneously with the process step 115 of processing the fine metallic alloy fiber 170. For example, the process step 116 of heating the fine metallic alloy fiber 170 may be undertaken simultaneously with the sintering of a matrix of the fine metallic alloy fibers 170. In the alternative, the process step 116 of heating the fine metallic alloy fiber 170 may be undertaken independently of the process step 115 of processing the fine metallic alloy fiber 170.

The fine metallic alloy fiber 170 are heated to a temperature sufficient to further diffuse the minimally diffused cladding material 130 into the metallic alloy fiber 170 to provide a substantially homogeneous fine metallic alloy fiber 170. The excess of the first alloy component (A) of the cladding material 130 at the periphery 190 of the fine metallic alloy fiber 170 further migrates or diffuses into the central region 195 of the fine metallic alloy fiber 170. The further migration or diffusion of the excess of the first alloy component (A) from the periphery 190 into the central region 195 of the fine metallic alloy fiber 170 results in a substantially uniform concentration of the first alloy component (A) and the second alloy component (B) throughout the fine metallic alloy fiber 170.

Preferably, the fine metallic alloy fiber 170 is heated to a temperature above 2100° F. The fine metallic alloy fiber 170 is heated at the temperature above 2100° F. for a period of time sufficient to further diffuse the diffused cladding material 140 into the metallic alloy fiber 170 to provide a substantially homogeneous fine metallic alloy fiber 170.

FIG. 19 is a view similar to FIG. 18 illustrating a homogeneous concentration of the first alloy component (A) and the second alloy component (13) throughout the fine metallic alloy fiber 170. The excess of the first alloy component (A) from the periphery 190 has migrated into the central region 195 of the fine metallic alloy fiber 170 to provide a substantially homogeneous fine metallic alloy fiber 170.

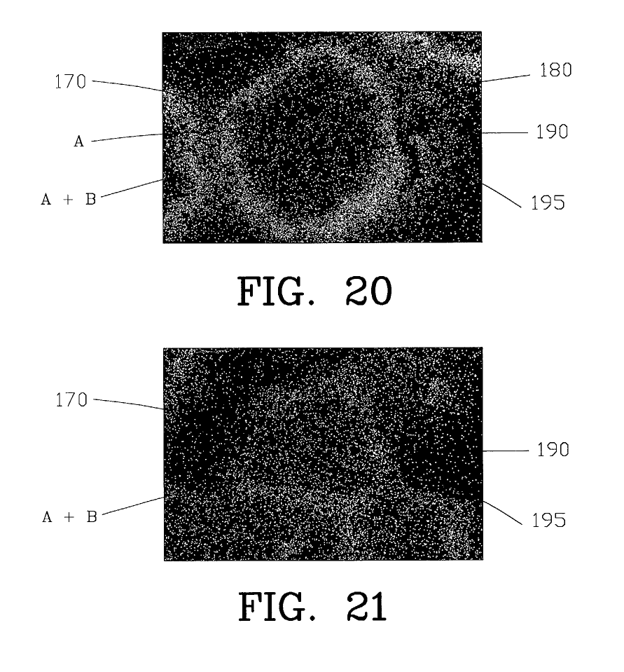

FIG. 20 is a photograph of the energy dispersive X-ray spectra illustrating the enhanced concentration 180 of diffused cladding material 130 at the periphery 190 of the fine metallic alloy fiber 170 of FIG. 18. The dots in the photograph indicated the concentration of the first alloy component (A) at the periphery 190 of the fine metallic alloy fiber 170.

FIG. 21 is a photograph of the energy dispersive X-ray spectra illustrating the homogeneous concentration of the diffused cladding material 130 within the fine metallic alloy fiber of FIG. 19. The dots in the photograph indicate the uniform concentration of the first alloy component (A) throughout the fine metallic alloy fiber 170.

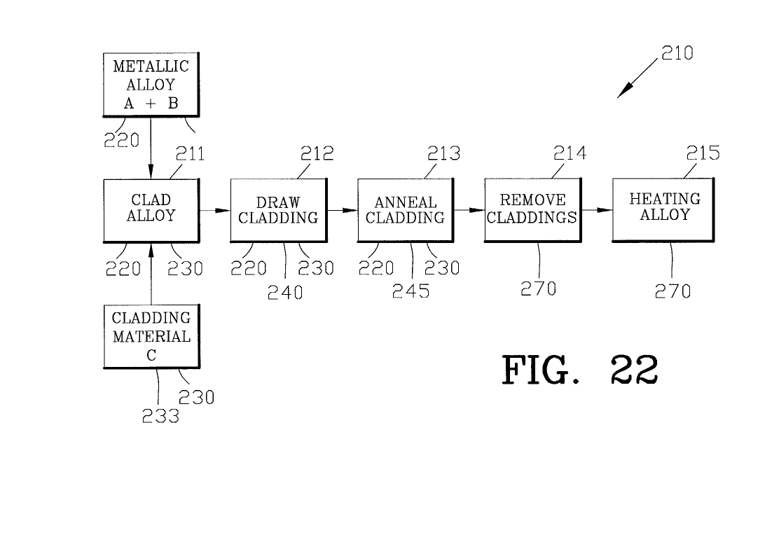

FIG. 22 is a block diagram of a third embodiment of an improved process 210 for making a fine metallic alloy fiber of the present invention. The third embodiment of the improved process 210 will be explained with reference to making a single metallic alloy fiber. It should be understood that the third process 210 may be modified to produce a multiplicity of fine metallic alloy fibers in a manner similar to the first process 10 shown in FIGS. 1-11.

The improved process 210 of FIG. 22 utilizes a metallic alloy 220 and a cladding material 230. The metallic alloy 220 is shown being formed from a first alloy component (A) and a second alloy component (B).

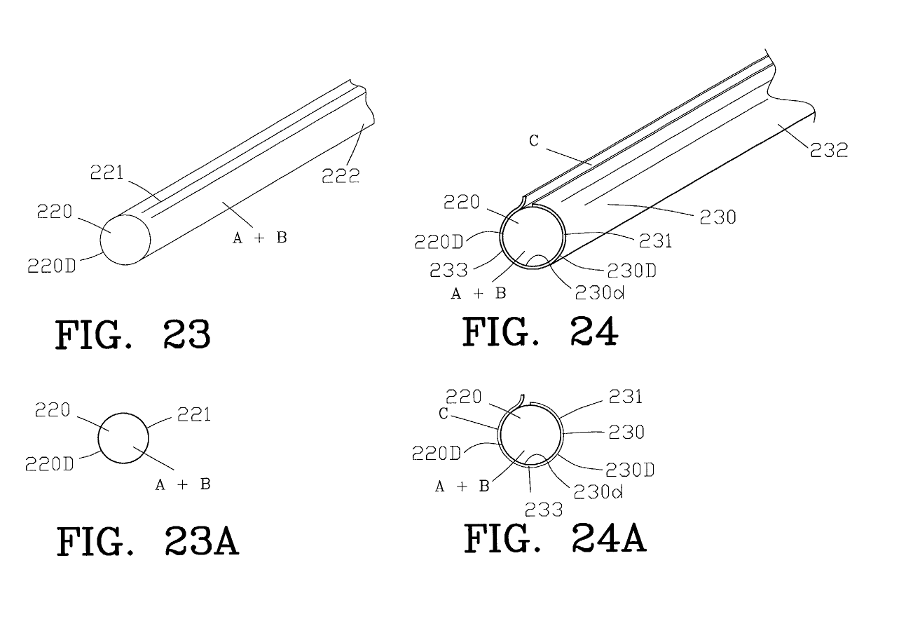

FIG. 23 is an isometric view of the metallic alloy wire 220 referred to in FIG. 22 with FIG. 23A being an end view of FIG. 23. The metallic alloy wire 220 extends between a first end 221 and a second end 222 and defines an outer diameter 220D. The metallic alloy 220 is shown being formed from the first alloy component (A) and the second alloy component (B).

FIG. 22 illustrates the process step 211 of cladding the metallic alloy wire 220 with the cladding material 230. The cladding material 230 is formed about the metallic alloy wire 220.

FIG. 24 is an isometric view illustrating a cladding material 230 referred to in FIG. 22. The cladding material 230 is shown being formed about the outer diameter 220D of the metallic alloy wire 220.

FIG. 24A is an enlarged end view of FIG. 24. The inner diameter 230d of the cladding material 230 is bent against the outer diameter 220D of the metallic alloy wire 220 to provide intimate contact between the cladding material 230 the outer diameter 220D of the metallic alloy wire 220.

The cladding material 230 is made of a material that is compatible with the selected metallic alloy 220. The cladding material 230 is formed from a third alloy component (C). The third alloy component (C) is different from the first alloy component (A) and the second alloy component (B).

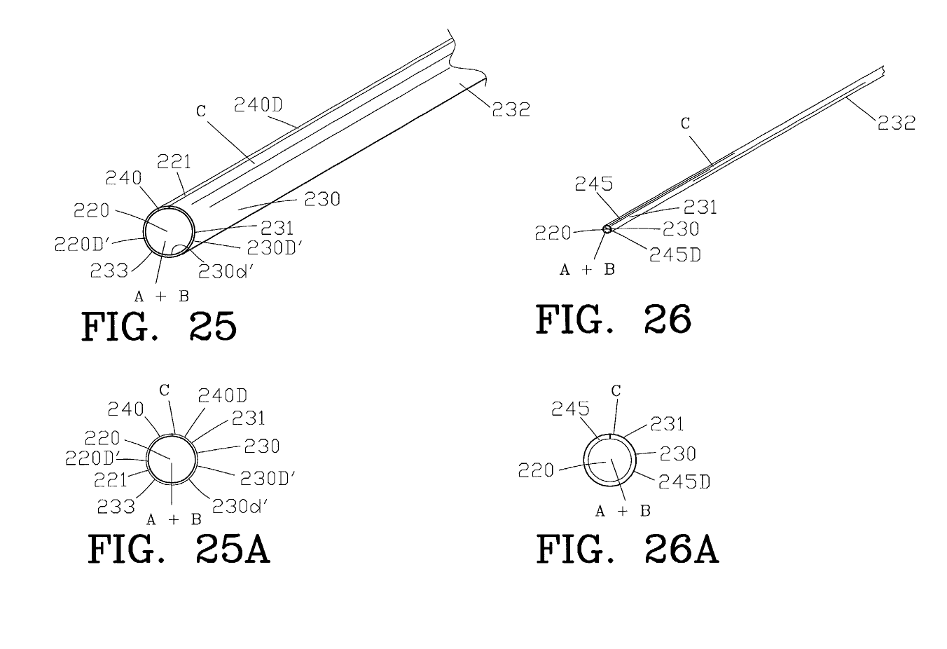

FIG. 25 is an isometric view similar to FIG. 24 illustrating the cladding material 230 encompassing the metallic alloy wire 220 with FIG. 25A being an enlarged end view of FIG. 25. The cladding material 230 is tightened about the metallic alloy wire 220 in the presence of an inert gas. The cladding material 230 is tightened onto the metallic alloy wire 220 to have a reduced outer diameter of 230D′ to form a cladding 240 having an outer diameter 240D.

FIG. 22 illustrates the process step 212 of drawing the cladding 240 for reducing the outer diameter 240D thereof and for reducing the diameter 220D′ of the metallic alloy wire 220 within the cladding 240 to provide a drawn cladding 245 having a outer diameter 245D.

FIG. 22 illustrates the process step 213 of annealing the drawn cladding 245. Preferably the drawing process 212 and the annealing process 213 of FIG. 22 are interrelated to include the successive drawing and the successive annealing of the cladding 245. The time and temperature of the annealing process 213 is established to control the diffusion of the clad material 230 into the metallic alloy wire 220. Preferably, the annealing of the cladding 240 takes place within a specialized atmosphere such as a reducing atmosphere as set forth previously

FIG. 26 is an isometric view of the drawn cladding 245 of FIG. 25 after the drawing process 212 and the annealing process 213 to provide the drawn cladding 245. The drawn cladding 245 defines the outer diameter 245D. The outer diameter 220D of the metallic alloy wire 220 is correspondingly reduced in the drawing process. The drawing of the cladding 240 transforms the metallic alloy wire 220 into a fine metallic alloy fiber 270.

FIG. 22 illustrates the process step 214 of removing the cladding material 230 from the fine metallic alloy fiber 270. Preferably, the cladding material 230 is removed from the fine metallic alloy fiber 270 by a chemical or an electrochemical process.

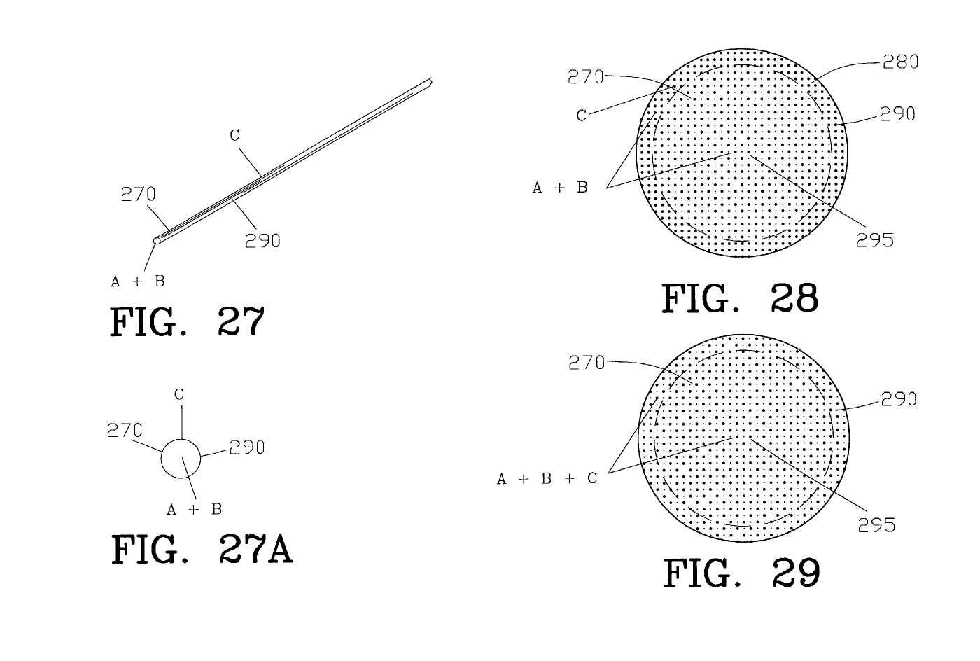

FIG. 27 is an isometric view similar to FIG. 26 illustrating the removal of the cladding material 230 to provide a fine metallic alloy fiber 270. The process step 214 of removing the cladding material 230 from the fine metallic alloy fiber 270 may include leaching the drawn cladding 245 for chemically removing the cladding material 230.

FIG. 27A is an enlarged end view of FIG. 27 illustrating the cross-section of the fine metallic alloy fiber 270. A portion of the clad material 230 has diffused into the metallic alloy fiber 270 during the annealing process 213. A concentration 280 of the diffused cladding material 230 is located at the periphery 290 of the fine metallic alloy fiber 270.

FIG. 28 is a magnified view of FIG. 27A illustrating the concentration 280 of diffused cladding material 230 at the periphery 290 of the fine metallic alloy fiber 270. During the annealing of the cladding 245, a portion of the cladding material 230 has migrated or diffused into the periphery 290 of the fine metallic alloy fiber 270.

A portion of the third alloy component (C) of the cladding material 230 has migrated or diffused into the periphery 290 of the fine metallic alloy fiber 270. The third alloy component (C) is different from the first alloy component (A) and the second alloy component (B) in a central region 295 of the fine metallic alloy fiber 270.

FIG. 22 illustrates the process step 215 of heating the fine metallic alloy fiber 270. The fine metallic alloy fiber 270 is heated to a temperature sufficient to further diffuse the diffused cladding material 230 into the metallic alloy fiber 270 to provide a fine metallic alloy fiber 270 formed from a new alloy. The new alloy is formed from the first alloy component (A) and the second alloy component (B) of the fine metallic alloy fiber 270 and the third alloy component (C) of the cladding material 230. Preferably, the fine metallic alloy fiber 270 is heated to a temperature above 2100° F. The fine metallic alloy fiber 270 may be heated at the temperature above 2100° F. for a period of time sufficient to diffuse the third alloy component (C) throughout the first alloy component (A) and the second alloy component (B). In the alternative, the fine metallic alloy fiber 270 may be heated at the temperature above 2100° F. for a period of time sufficient to only partially diffuse the third alloy component (C) into the first alloy component (A) and the second alloy component (B)

FIG. 29 is a view similar to FIG. 28 illustrating the new alloy formed from the first alloy component (A), the second alloy component (B) and the third alloy component (C). The third alloy component (C) has been totally and uniformly diffused throughout the first alloy component (A) and the second alloy component (B).

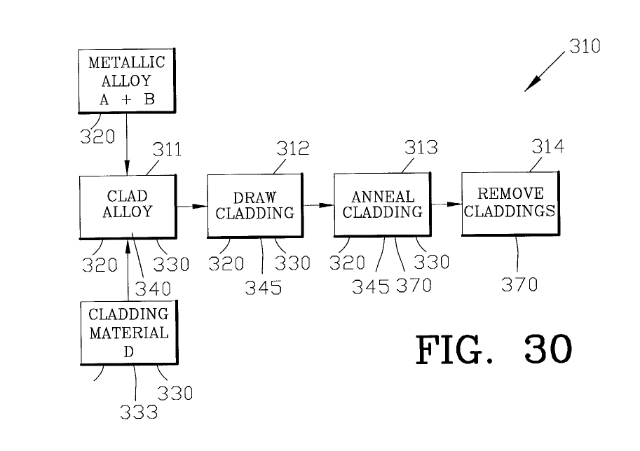

FIG. 30 is a block diagram of a fourth embodiment of an improved process 310 for making a fine metallic alloy fiber of the present invention. The third embodiment of the improved process 310 will be explained with reference to making a single metallic alloy fiber. It should be understood that the third process 310 may be modified to produce a multiplicity of fine metallic alloy fibers in a manner similar to the first process 10 shown in FIGS. 1-11.

The improved process 310 of FIG. 30 utilizes a metallic alloy 320 and a cladding material 330. The metallic alloy 320 is shown being formed from a first alloy component (A) and a second alloy component (B).

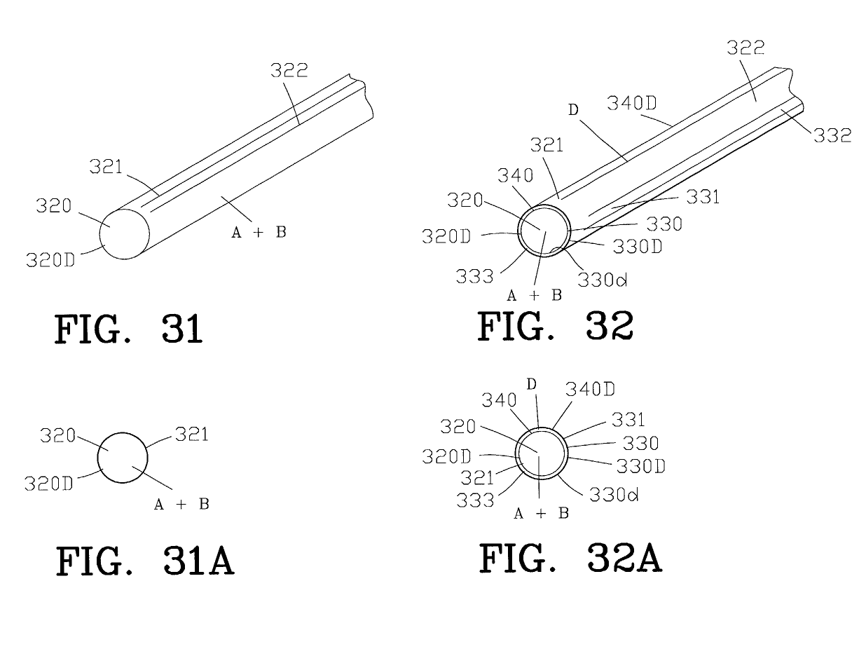

FIG. 31 is an isometric view of the metallic alloy wire 320 referred to in FIG. 30 with FIG. 31A being an end view of FIG. 31. The metallic alloy wire 320 extends between a first end 321 and a second end 322 and defines an outer diameter 320D. The metallic alloy 320 is shown being formed from the first alloy component (A) and the second alloy component (B).

FIG. 30 illustrates the process step 311 of cladding the metallic alloy wire 320 with the cladding material 330. The cladding material 230 is electroplated onto the metallic alloy wire 320.

FIG. 32 is an isometric view illustrating a cladding material 330 referred to in FIG. 30. The cladding material 330 is shown electoplated on the outer diameter 320D of the metallic alloy wire 320.

FIG. 32A is an enlarged end view of FIG. 32. The inner diameter 330d of the cladding material 230 provides intimate contact with the outer diameter 320D of the metallic alloy wire 320. The cladding material 330 is made of a material that is compatible with the selected metallic alloy 320. The cladding material 340 is formed from a fourth component (D). The fourth component (D) is different from the first alloy component (A) and the second alloy component (B). The fourth component (D) may be an alloy material or a non-alloy material.

FIG. 30 illustrates the process step 312 of drawing the cladding 340 for reducing the outer diameter 340D thereof and for reducing the diameter 320D of the metallic alloy wire 220 within the cladding 240 to provide a drawn cladding 245 having a outer diameter 245D.

FIG. 30 illustrates the process step 313 of annealing the drawn cladding 345. Preferably the drawing process 312 and the annealing process 313 of FIG. 30 are interrelated to include the successive drawing and the successive annealing of the cladding 345. The time and temperature of the annealing process 313 is established to control the diffusion of the clad material 3330 into the metallic alloy wire 320. Preferably, the annealing of the cladding 340 takes place within a specialized atmosphere such as a reducing atmosphere as set forth previously.

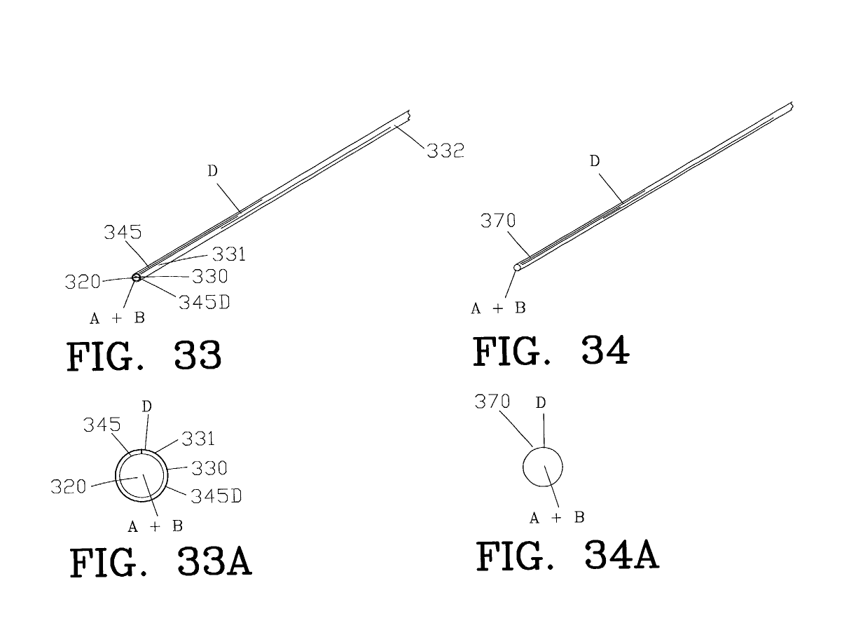

FIG. 33 is an isometric view of the drawn cladding 345 of FIG. 30 after the drawing process 312 and the annealing process 313 to provide the drawn cladding 345. The drawn cladding 345 defines the outer diameter 345D. The drawing of the cladding 345 transforms the metallic alloy wire 320 into a fine metallic alloy fiber 370.

FIG. 30 illustrates the process step 314 of removing the cladding material 330 from the fine metallic alloy fiber 370. Preferably, the cladding material 330 is removed from the fine metallic alloy fiber 370 by a chemical or an electrochemical process.

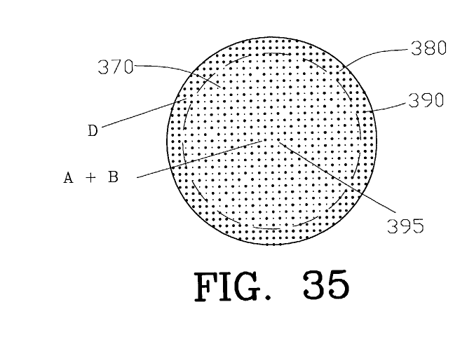

FIG. 34 is an isometric view similar to FIG. 33 illustrating the removal of the cladding material 330 to provide a fine metallic alloy fiber 370.

FIG. 34A is an enlarged end view of FIG. 34 illustrating the cross-section of the fine metallic alloy fiber 370. A portion of the clad material 330 has diffused into the metallic alloy fiber 370 during the annealing process 213. A concentrated 380 of the diffused cladding material 330 is located at the periphery 390 of the fine metallic alloy fiber 370.

FIG. 35 is a magnified view of FIG. 34A illustrating the concentration 380 of diffused cladding material 330 at the periphery 390 of the fine metallic alloy fiber 370. During the annealing of the cladding 345, a portion of the cladding material 330 has migrated or diffused into the periphery 390 of the fine metallic alloy fiber 370.

A portion of the fourth component (D) of the cladding material 330 has migrated or diffused into the periphery 390 of the fine metallic alloy fiber 370. The fourth component (D) is different from the first alloy component (A) and the second alloy component (B) in a central region 295 of the fine metallic alloy fiber 370.

The fourth component (D) located on the periphery 390 of the fine metallic alloy fiber 370 providing a fine metallic alloy fiber 370 having surface properties in accordance with the properties of the cladding material 330. The surface properties of the fine metallic alloy fiber 370 is in accordance with the properties of the fourth component (D).

The following Examples I-V set forth specific parameters for the processes of the present invention. It should be appreciated by those skilled in the art that the EXAMPLES I-V may be modified for providing other processes and should not be construed to be limiting upon the present invention.

### EXAMPLE I

ANNEALING CLADDING

| | |
|---|---|
| OBJECT: | General annealing of alloy fiber to preserve original |
| | composition |
| PROCESS: | Temperature 0.8 of melting point of alloy to be annealed |
| | Time of surface diffusion during annealing measured in |
| | seconds to minutes |
| RESULT: | Alloy fiber annealed with minimal diffusion of cladding |
| | into the ally fibers |

### EXAMPLE II

DIFFUSION

| | |
|---|---|
| OBJECT: | General sintering of alloy fibers to diffuse to diffuse |
| | cladding into alloy fibers |
| PROCESS: | Temperature 0.90 to 0.95 of melting point of alloy |
| | Time of volume diffusion during sintering measured in |
| | hours |
| RESULT: | Cladding material fully diffused |

### EXAMPLE III

ADVANCED ALLOY HAYNES C-2000

| | |
|---|---|
| OBJECT: | To make a final composition: 59%Ni; 23%Cr; 16%Mo; |
| | 1.6%Cu. |
| PROCESS: | Metallic alloy wire having a composition |
| | 59%Ni—23%Cr—16%Mo (with no copper) is clad with a |
| | copper cladding material to form a cladding. The |
| | cladding is drawn using intermediate annealing. An |
| | excess of copper clad material is diffused on the |
| | peripheral surface of the fiber. After a heating process |
| | the copper diffuses into the central region of the fiber. |
| RESULT: | The final composition is Ni—Cr—Mo—Cu. |

### EXAMPLE IV

ADVANCED SURFACE LAYER

| | |
|---|---|
| OBJECT: | To make a surface layer with properties different from the |
| | composition of the fiber |
| PROCESS: | Nickel rod is plated or cladded with a copper cladding |
| | material. A thin diffusion layer of nickel-copper |
| | alloy is formed during the drawings and annealing process. |
| RESULT: | The alloy is designed to match the composition of Monel |
| | type alloy (Monel 400 for example) to withstand the |
| | exposure to fluorine/fluoride-bearing reducing |
| | environment. |

### EXAMPLE V

ADVANCED SURFACE LAYER

| | |
|---|---|
| OBJECT: | To make a fiber with a surface layer of precious metal for |
| | catalytic processes or jewelry applications |
| PROCESS: | Low cost metal is plated by precious metal such as platinum |
| | A thin diffusion layer of platinum alloy is formed |
| | during the drawings and annealing process. |
| RESULT: | Precious metal layer on low cost substrate |

The present invention provides fine fiber made from a metallic alloy and a new process for forming the fiber from a metallic alloy. The process is capable of forming fiber from a metallic alloy wherein the fine metallic alloy fiber has a diameter less than ten microns. The process is capable of forming high quality fine metallic alloy fibers at an economical cost in commercial quantities.

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A process for making a fine metallic alloy fiber, comprising the steps of:
encompassing a metallic alloy wire with a cladding material;
tightening the cladding material about the metallic alloy wire in the presence of an inert atmosphere to provide a cladding;
drawing the cladding for reducing the outer diameter thereof and for reducing the diameter of the metallic alloy wire to provide a fine metallic alloy fiber from the metallic alloy wires; and
removing the cladding materials from the fine metallic alloy fiber.

2. A process for making a fine metallic alloy fiber as set forth in claim 1, wherein the step of encompassing the metallic alloy wire with the cladding material includes inserting the metallic alloy wire into a preformed tube of the cladding material.

3. A process for making a fine metallic alloy fiber as set forth in claim 1, wherein the step of encompassing the metallic alloy wire with the cladding material includes forming the cladding material about the metallic alloy wire.

4. A process for making a fine metallic alloy fiber as set forth in claim 1, wherein the step of tightening the cladding material about the metallic alloy wire comprises tightening the cladding material about the metallic alloy wire in the presence of an inert gas located between the cladding material and the metallic alloy wire.

5. A process for making a fine metallic alloy fiber as set forth in claim 1, wherein the step of tightening the cladding material about the metallic alloy wire comprises sealing the cladding material to a first end of the metallic alloy wire;
introducing an inert gas between the cladding material and the metallic alloy wire from a second end of the metallic alloy wire; and
drawing the cladding material and the metallic alloy wire through a reducing die for tightening the cladding material onto the metallic alloy wire from the first end of the metallic alloy wire to the second end of the metallic alloy wire.

6. A process for making a fine metallic alloy fiber as set forth in claim 1, wherein the step of drawing the cladding includes successively drawing and annealing the cladding.

7. A process for making a fine metallic alloy fiber as set forth in claim 1, wherein the step of drawing the cladding includes successively drawing the cladding; and
successively annealing the cladding at a temperature between 1650° F. and 2050° F.

8. A process for making a fine metallic alloy fiber as set forth in claim 1, wherein the step of drawing the cladding includes successively drawing the cladding;
successively annealing the cladding at a temperature between 1650° F. and 2050° F.; and
rapidly cooling the cladding in a heat conducting fluid after the annealing process.

9. A process for making a fine metallic alloy fiber as set forth in claim 1, wherein the step of drawing the cladding includes successively drawing the cladding; and successively annealing the cladding at a temperature between 1650° F. and 2050° F. within an inert atmosphere.

10. A process for making a fine metallic alloy fiber as set forth in claim 1, wherein the step of drawing the cladding includes successively drawing the cladding; and
successively annealing the cladding at a temperature between 1650° F. and 2050° F. within a reducing atmosphere.

11. A process for making fine metallic alloy fibers, comprising the steps of:
encompassing a metallic alloy wire with a first cladding material;
tightening the first cladding material about the metallic alloy wire in the presence of an inert atmosphere to provide a first cladding;
drawing the first cladding for reducing the outer diameter thereof and for reducing the diameter of the metallic alloy wire within the first cladding to provide a drawn first cladding;
assembling a multiplicity of the drawn first claddings within a second cladding material to form a second cladding;
drawing the second cladding for reducing the diameter thereof and for providing a multiplicity of fine metallic alloy fibers from the multiplicity of metallic alloy wires; and
removing the first and second cladding materials from the multiplicity of fine metallic alloy fibers.

12. A process for making fine metallic alloy fibers as set forth in claim 11, wherein the step of cladding the multiplicity of the drawn first claddings within a second cladding material to form a second cladding includes inserting the multiplicity of the drawn first claddings into a preformed second cladding material.

13. A process for making fine metallic alloy fibers as set forth in claim 11, wherein the step of cladding the multiplicity of the drawn first claddings within a second cladding material to form a second cladding includes forming the second cladding material about the multiplicity of the drawn first claddings.

14. A process for making fine metallic alloy fibers as set forth in claim 11, wherein the step of drawing the second cladding includes successively drawing and annealing the second cladding.

15. A process for making fine metallic alloy fibers as set forth in claim 11, wherein the step of drawing the second cladding includes successively drawing the second cladding; and
successively annealing the second cladding at a temperature between 1650° F. and 2050° F.

16. A process for making fine metallic alloy fibers as set forth in claim 11, wherein the step of drawing the second cladding includes successively drawing the second cladding;
successively annealing the second cladding at a temperature between 1650° F. and 2050° F.; and
rapidly cooling the second cladding in a heat conducting fluid after the annealing process.

17. A process for making fine metallic alloy fibers as set forth in claim 11, wherein the step of drawing the second cladding includes successively drawing the second cladding; and
successively annealing the second cladding at a temperature of between 1650° F. and 2050° F. within a specialized atmosphere.

18. A process for making fine metallic alloy fibers as set forth in claim 11, wherein the step of drawing the second cladding includes successively drawing the second cladding; and
successively annealing the second cladding at a temperature between 1650° F. and 2050° F. within an inert atmosphere.

19. A process for making fine metallic alloy fibers as set forth in claim 11, wherein the step of drawing the second cladding includes successively drawing the second cladding; and
successively annealing the second cladding at a temperature between 1650° F. and 2050° F. within a reducing atmosphere.

20. A process for making fine metallic alloy fibers as set forth in claim 11, wherein the step of removing the first and second cladding includes chemically removing the first and second claddings.

21. A process for making a fine metallic alloy fiber, comprising the steps of:
providing a metallic alloy wire formed from a first and a second alloy component;
providing a cladding material formed from one of the first and second alloy components;
encompassing the metallic alloy wire with the cladding material to provide a cladding;
drawing the cladding for reducing the outer diameter thereof and for reducing the diameter of the metallic alloy wire to provide a drawn cladding having a fine metallic alloy fiber formed from the metallic alloy wire;
heating the drawn cladding to a temperature sufficient for annealing the drawn cladding with minimal diffusion of the cladding material into the fine metallic alloy fiber;
removing the cladding material from the fine metallic alloy fiber; and
heating the fine metallic alloy fiber to a temperature sufficient to further diffuse the minimal diffused cladding material into the metallic alloy fiber to provide a substantially homogeneous fine metallic alloy fiber.

22. A process for making a fine metallic alloy fiber as set forth in claim 1, wherein the step of encompassing the alloy wire with the cladding material includes tightening the cladding material about the metallic alloy wire in the presence of an inert gas located between the cladding material and the metallic alloy wire.

23. A process for making a fine metallic alloy fiber as set forth in claim 21, wherein the step of tightening the cladding material about the metallic alloy wire comprises sealing the cladding material to a first end of the metallic alloy wire;
introducing an inert gas between the cladding material and the metallic alloy wire from a second end of the metallic alloy wire; and
drawing the cladding material and the metallic alloy wire through a reducing die for tightening the cladding material onto the metallic alloy wire from the first end of the metallic alloy wire to the second end of the metallic alloy wire.

24. A process for making a fine metallic alloy fiber as set forth in claim 21, wherein the step of heating the cladding includes annealing the cladding at a temperature between 1650° F. and 2050° F.

25. A process for making a fine metallic alloy fiber as set forth in claim 21, wherein the step of heating the cladding includes annealing the cladding at a temperature between 1650° F. and 2050° F.; and
rapidly cooling the cladding within a heat conducting fluid after the annealing process.

26. A process for making a fine metallic alloy fiber as set forth in claim 21, wherein the step of drawing the cladding includes successively drawing the cladding; and
successively annealing the cladding at a temperature between 1650° F. and 2050° F. within an inert atmosphere.

27. A process for making a fine metallic alloy fiber as set forth in claim 21, wherein the step of drawing the cladding includes successively drawing the cladding; and
successively annealing the cladding at a temperature between 1650° F. and 2050° F. within a reducing atmosphere.

28. A process for making a fine metallic alloy fiber as set forth in claim 21, wherein the step of heating the fine metallic alloy fiber includes heating the fine metallic alloy fiber to a temperature above 2100° F. for a period of time sufficient to diffuse the minimal diffused cladding material into the metallic alloy fiber to provide a substantially homogeneous fine metallic alloy fiber.

29. A process for making a fine metallic alloy fiber as set forth in claim 21, wherein the step of removing the cladding includes chemically removing the cladding material from the fine metallic alloy fiber.

30. A process for making fine metallic alloy fibers, comprising the steps of:
providing a metallic alloy wire formed from a first and a second alloy component;
providing a first cladding material formed from one of the first and second alloy components;
encompassing the metallic alloy wire with the cladding material;
tightening the first cladding material about the metallic alloy wire in the presence of an inert atmosphere to provide a first cladding;
drawing the first cladding for reducing the outer diameter thereof and for reducing the diameter of the metallic alloy wire within the first cladding to provide a drawn first cladding;
heating the drawn first cladding to a temperature sufficient for annealing the drawn first cladding with minimal diffusion of the first cladding material into the metallic alloy wire;
assembling a multiplicity of the drawn first claddings within a second cladding material to form a second cladding;
drawing the second cladding for reducing the diameter thereof and for providing a multiplicity of fine metallic alloy fibers from the multiplicity of metallic alloy wires;
removing the first and second cladding materials from the multiplicity of fine metallic alloy fibers; and
heating the multiplicity of fine metallic alloy fibers to a temperature sufficient to further diffuse the minimal diffused first cladding material into the metallic alloy fiber to provide substantially homogeneous fine metallic alloy fibers.

31. A process for making a fine metallic alloy fiber, comprising the steps of:
providing a metallic alloy wire formed from a first and a second alloy component;
providing a cladding material formed from a material different from the first and second alloy components;
encompassing the metallic alloy wire with the cladding material to provide a cladding;
drawing the cladding for reducing the outer diameter thereof and for reducing the diameter of the metallic alloy wire to provide a drawn cladding having a fine metallic alloy fiber formed from the metallic alloy wire;
heating the drawn cladding to a temperature sufficient for annealing the drawn cladding and for diffusing the cladding material into the metallic alloy fiber;
removing the cladding material from the fine metallic alloy fiber; and
heating the fine metallic alloy fiber to a temperature sufficient to further diffuse the diffused cladding material into the metallic alloy fiber to provide a fiber formed from a new alloy comprising the first and second alloy component and the diffused cladding material.

32. A process for making a fine metallic alloy fiber as set forth in claim 31, wherein the step of encompassing the alloy wire with the cladding material includes tightening the cladding material about the metallic alloy wire in the presence of an inert gas located between the cladding material and the metallic alloy wire.

33. A process for making a fine metallic alloy fiber as set forth in claim 31, wherein the step of heating the cladding includes annealing the cladding at a temperature between 1650° F. and 2050° F.

34. A process for making a fine metallic alloy fiber as set forth in claim 31, wherein the step of heating the cladding includes annealing the cladding at a temperature between 1650° F. and 2050° F.; and
rapidly cooling the cladding within a heat conducting fluid after the annealing process.

35. A process for making a fine metallic alloy fiber as set forth in claim 31, wherein the step of drawing the cladding includes successively drawing the cladding; and
successively annealing the cladding at a temperature between 1650° F. and 2050° F. within an inert atmosphere.

36. A process for making a fine metallic alloy fiber as set forth in claim 31, wherein the step of drawing the cladding includes successively drawing the cladding; and
successively annealing the cladding at a temperature between 1650° F. and 2050° F. within a reducing atmosphere.

37. A process for making a fine metallic alloy fiber as set forth in claim 31, wherein the step of heating the fine metallic alloy fiber includes heating the fine metallic alloy fiber to a temperature above 2100° F. for a period of time sufficient to diffuse the cladding material into the metallic alloy fiber to provide a substantially homogeneous fine metallic alloy fiber.

38. A process for making a fine metallic alloy fiber as set forth in claim 31, wherein the step of removing the cladding includes chemically removing the cladding material from the fine metallic alloy fiber.

39. A process for making fine metallic alloy fibers, comprising the steps of:
providing a metallic alloy wire formed from a first and a second alloy component;
providing a first cladding material formed from a material different from the first and second alloy components;
encompassing the metallic alloy wire with the cladding material;
tightening the first cladding material about the metallic alloy wire in the presence of an inert atmosphere to provide a first cladding;
drawing the first cladding for reducing the outer diameter thereof and for reducing the diameter of the metallic alloy wire within the first cladding to provide a drawn first cladding;
heating the drawn first cladding to a temperature sufficient for annealing the drawn first cladding and for diffusing the first cladding material into the metallic alloy wire;
assembling a multiplicity of the drawn first claddings within a second cladding material to form a second cladding;
drawing the second cladding for reducing the diameter thereof and for providing a multiplicity of fine metallic alloy fibers from the multiplicity of metallic alloy wires;
removing the first and second cladding materials from the multiplicity of fine metallic alloy fibers; and
heating the multiplicity of fine metallic alloy fibers to a temperature sufficient to further diffuse the first cladding material into the metallic alloy fibers to provide fine metallic alloy fibers formed from a new alloy comprising the first and second alloy component and the diffused first cladding material.

40. A process for making fine metallic alloy fiber, comprising the steps of:
providing a metallic alloy wire formed from a first and a second alloy component;
providing a cladding material formed from a material different from the first and second alloy components;
encompassing the metallic alloy wire with the cladding material to provide a cladding;
drawing the cladding for reducing the outer diameter thereof and for reducing the diameter of the metallic alloy wire to provide a drawn cladding having a fine metallic alloy fiber formed from the metallic alloy wire;
heating the drawn cladding to a temperature sufficient for annealing the drawn cladding and for diffusing the cladding material into the surface of the metallic alloy fiber;
removing the cladding material for providing a fine metallic alloy fiber having surface properties in accordance with the properties of the cladding material.

41. A process for making fine metallic alloy fibers, comprising the steps of:
providing a metallic alloy wire formed from a first and a second alloy component;
providing a first cladding material formed from a material different from the first and second alloy components;
encompassing the metallic alloy wire with the cladding material;
tightening the first cladding material about the metallic alloy wire in the presence of an inert atmosphere to provide a first cladding;
drawing the first cladding for reducing the outer diameter thereof and for reducing the diameter of the metallic alloy wire within the first cladding to provide a drawn first cladding;
heating the drawn first cladding to a temperature sufficient for annealing the drawn first cladding and for diffusing the first cladding material into the surface of the metallic alloy wire;
assembling a multiplicity of the drawn first claddings within a second cladding material to form a second cladding;
drawing the second cladding for reducing the diameter thereof and for providing a multiplicity of fine metallic alloy fibers from the multiplicity of metallic alloy wires; and
removing the first and second cladding materials from the multiplicity of fine metallic alloy fibers for providing a multiplicity of fine metallic alloy fibers fiber having surface properties in accordance with the properties of the first cladding material.
